(19) United States
(12) Patent Application Publication
(10) Pub. No.: US 2020/0004242 A1
(43) Pub. Date: Jan. 2, 2020

(54) METHOD FOR MANAGING DRIVE OF VEHICLE IN AUTONOMOUS DRIVING SYSTEM AND APPARATUS THEREOF

(71) Applicant: LG Electronics Inc., Seoul (KR)

(72) Inventor: Soryoung Kim, Seoul (KR)

(21) Appl. No.: 16/558,002

(22) Filed: Aug. 30, 2019

(30) Foreign Application Priority Data
Aug. 7, 2019 (KR) 10-2019-0096270

(51) Int. Cl. G05D 1/00

(52) U.S. Cl. CPC G05D 1/0055; G06Q 50/265; G05D 2201/0213; G05D 1/0088

(57) ABSTRACT

Disclosed herein are a method and an apparatus for managing a vehicle in an autonomous driving system. The operating method of a server for managing the drive of the vehicle in the autonomous driving system includes collecting data on a dangerous drive of a danger candidate vehicle from a plurality of vehicles, determining whether the danger candidate vehicle is a dangerous vehicle or not on the basis of the data on the dangerous drive and information about a driving environment of the danger candidate vehicle, and performing an operation responding to a dangerous driving cause of the danger candidate vehicle if the danger candidate vehicle is the dangerous vehicle. The above-described method makes it possible to monitor a dangerously driving vehicle and thus take appropriate measures against the dangerously driving vehicle. One or more of an autonomous vehicle, a user terminal and a server of the present disclosure can be associated with artificial intelligence modules, drones (unmanned aerial vehicles (UAVs)), robots, augmented reality (AR) devices, virtual reality (VR) devices, devices related to 5G service, etc.

### CROSS-REFERENCE TO RELATED APPLICATION

This application claims the benefit of Korean Patent Application No. 10-2019-0096270 filed on Aug. 7, 2019, the entire contents of which is incorporated herein by reference for all purposes as if fully set forth herein.

### BACKGROUND

### Field of the Disclosure

The present disclosure relates to a method and an apparatus for managing a vehicle in an autonomous driving system and, more particularly, to a method and an apparatus intended to identify a dangerous vehicle in an autonomous driving system and to perform a corresponding operation depending on a dangerous driving cause.

### Description of the Background

Vehicles, in accordance with the prime mover that is used, can be classified into an internal combustion engine vehicle, an external combustion engine vehicle, a gas turbine vehicle, an electric vehicle or the like.

An autonomous vehicle refers to a vehicle that can be driven by itself without operation by a driver or a passenger and an autonomous driving system refers to a system that monitors and controls such an autonomous vehicle so that the autonomous vehicle can be driven by itself.

In the autonomous driving system, there is an increasing demand for technology that controls the vehicle to rapidly drive the vehicle to a destination, as well as technology that provides a safer driving environment to passengers or pedestrians.

### SUMMARY

An object of the present disclosure is to solve the necessities and/or problems described above.

Furthermore, the present disclosure is to provide a safe driving environment in an autonomous driving system.

Furthermore, the present disclosure is to realize a method and an apparatus for monitoring a dangerously driving vehicle in an autonomous driving system.

Furthermore, the present disclosure is to realize a method and an apparatus for providing a corresponding operation suitable for a dangerous vehicle in an autonomous driving system.

An embodiment of the present disclosure is to provide an operating method of a server for managing a drive of a vehicle in an autonomous driving system, including collecting data on a dangerous drive of a danger candidate vehicle, determining whether the danger candidate vehicle is a dangerous vehicle or not on the basis of the data on the dangerous drive and information about a driving environment of the danger candidate vehicle, and performing an operation responding to a dangerous driving cause of the danger candidate vehicle if the danger candidate vehicle is the dangerous vehicle.

Another embodiment of the present disclosure is to provide a server for managing a drive of a vehicle in an autonomous driving system, including a transceiver configured to transmit or receive a signal, a processor coupled to the transceiver, and a memory coupled to the processor, wherein the processor collects data on a dangerous drive of a danger candidate vehicle, determines whether the danger candidate vehicle is a dangerous vehicle or not on the basis of the data on the dangerous drive and information about a driving environment of the danger candidate vehicle, and performs an operation responding to a dangerous driving cause of the danger candidate vehicle if the danger candidate vehicle is the dangerous vehicle.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure. In the drawings:

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a diagram showing a signal flow in an autonomous vehicle according to an embodiment of the present disclosure.

FIG. 9 is a diagram illustrating a user utilization scenario according to an embodiment of the present disclosure.

FIG. 10 illustrates V2X communication to which the present disclosure is applicable.

FIG. 11 illustrates a resource allocation method at a sidelink in which V2X is used.

FIG. 12 shows an example of a block diagram of an autonomous driving system according to an embodiment of the present disclosure.

FIG. 13 shows an example of a block diagram of a server in an autonomous driving system according to an embodiment of the present disclosure.

FIG. 14 shows an example of a block diagram of a monitoring vehicle in an autonomous driving system according to an embodiment of the present disclosure.

FIG. 15 shows an example of a block diagram of a danger candidate vehicle in an autonomous driving system according to an embodiment of the present disclosure.

FIG. 16 shows another example of a block diagram of an autonomous driving system according to an embodiment of the present disclosure.

FIG. 17 shows an example of an operating method of a server in an autonomous driving system according to an embodiment of the present disclosure.

FIG. 18 shows an example of an operating method of the server for determining a dangerous vehicle in the autonomous driving system according to the embodiment of the present disclosure.

FIG. 19 shows an example of an operating method of the server for performing a corresponding operation depending on a dangerous driving cause in the autonomous driving system according to the embodiment of the present disclosure.

FIG. 20 shows an example of an operating method of the server for setting a driving limit for a passenger in the autonomous driving system according to the embodiment of the present disclosure.

FIG. 21 shows another example of the operating method of the server for performing the corresponding operation depending on the dangerous driving cause in the autonomous driving system according to the embodiment of the present disclosure.

FIG. 22 shows an example of an operating method of a monitoring vehicle in the autonomous driving system according to the embodiment of the present disclosure.

FIG. 23 shows an example of an operating method of a danger candidate vehicle in the autonomous driving system according to the embodiment of the present disclosure.

FIG. 24 shows another example of the operating method of the server in the autonomous driving system according to the embodiment of the present disclosure.

FIG. 25 shows an example of an operation flowchart for managing the vehicle in the autonomous driving system according to the embodiment of the present disclosure.

FIG. 26 shows another example of the operation flowchart for managing the vehicle in the autonomous driving system according to the embodiment of the present disclosure.

FIG. 27 shows a further example of the operation flowchart for managing the vehicle in the autonomous driving system according to the embodiment of the present disclosure.

FIG. 28 shows yet another example of the operation flowchart for managing the vehicle in the autonomous driving system according to the embodiment of the present disclosure.

The accompanying drawings, which are included as a part of the detailed description to provide the thorough understanding of the present disclosure, provide an embodiment of the present disclosure and describe the technical features of the present disclosure together with the detailed description.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereafter, a device that requires autonomous driving information and/or 5G communication (5th generation mobile communication) that an autonomous vehicle requires are described through a paragraph A to a paragraph G.

A. Example of Block Diagram of UE and 5G Network

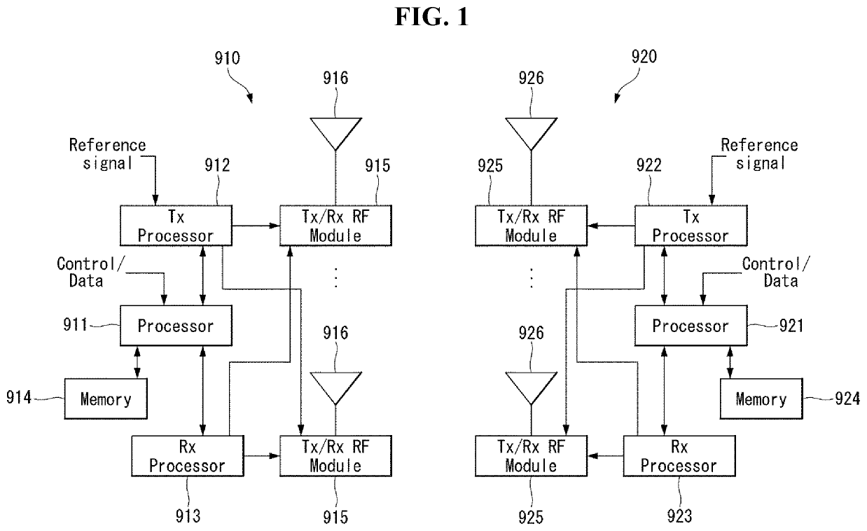

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

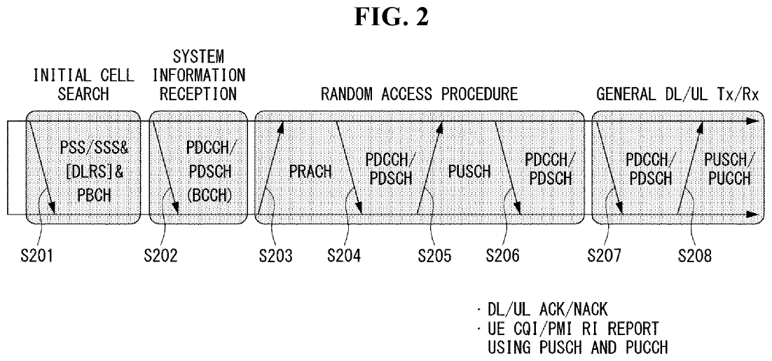

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlockl) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-S SB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequency Sect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

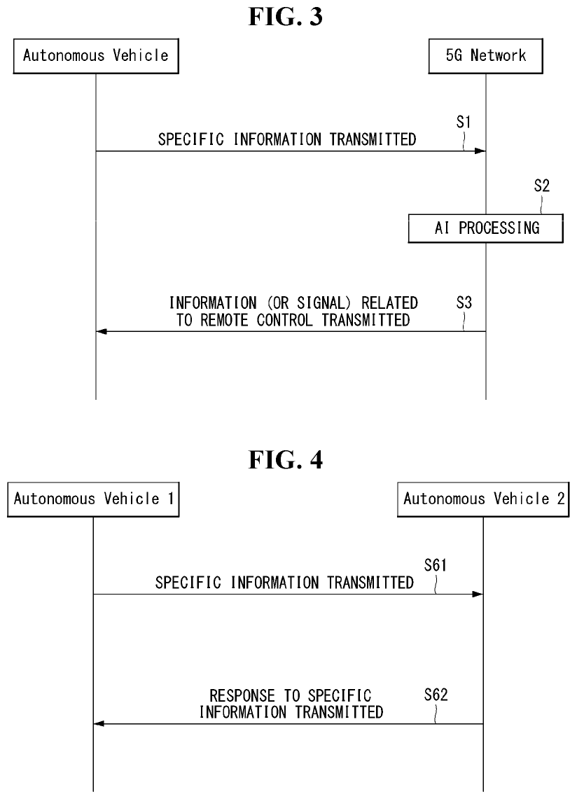

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

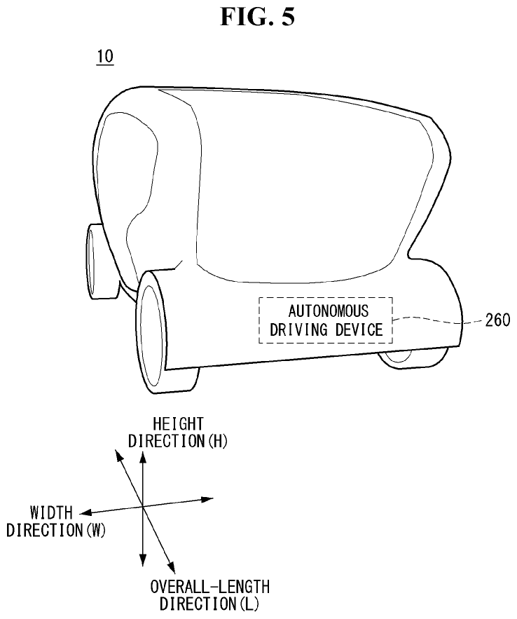

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

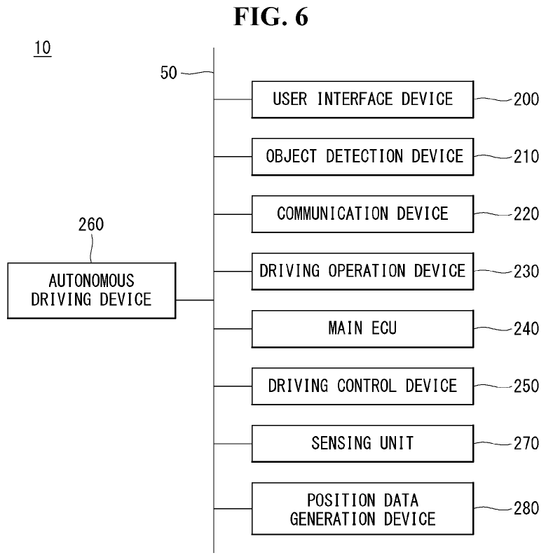

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

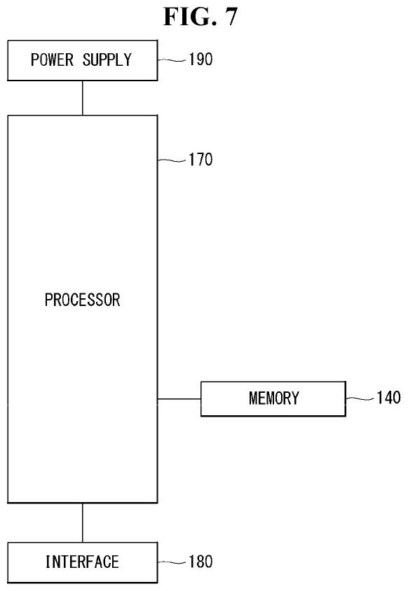

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a transceiver (or transceiver), a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

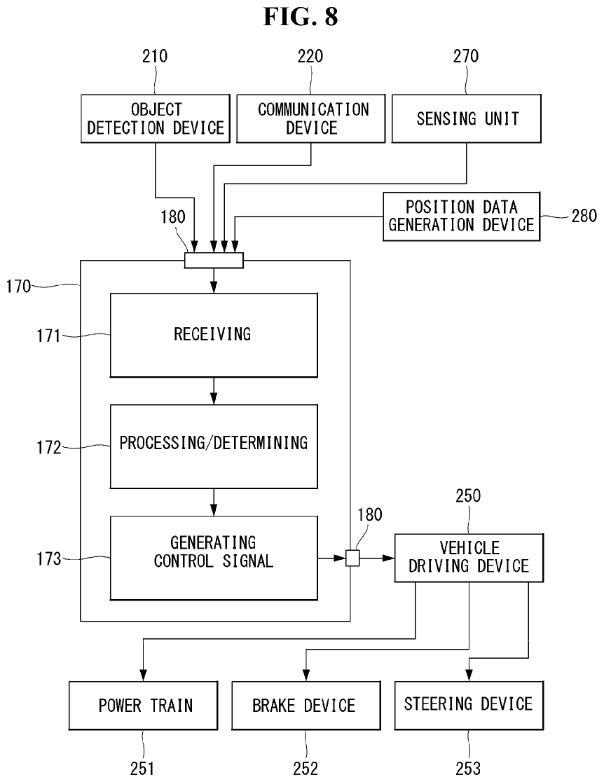

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

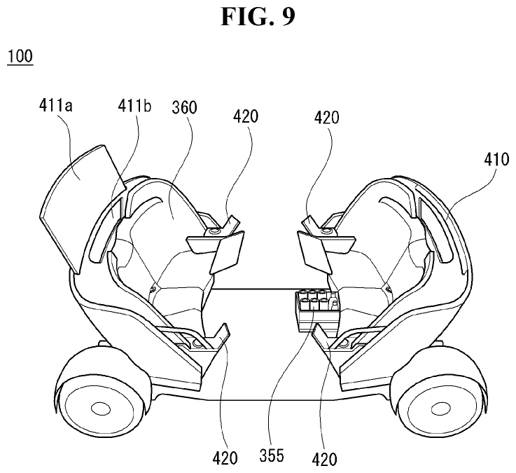

FIG. 9 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

V2X (Vehicle-to-Everything)

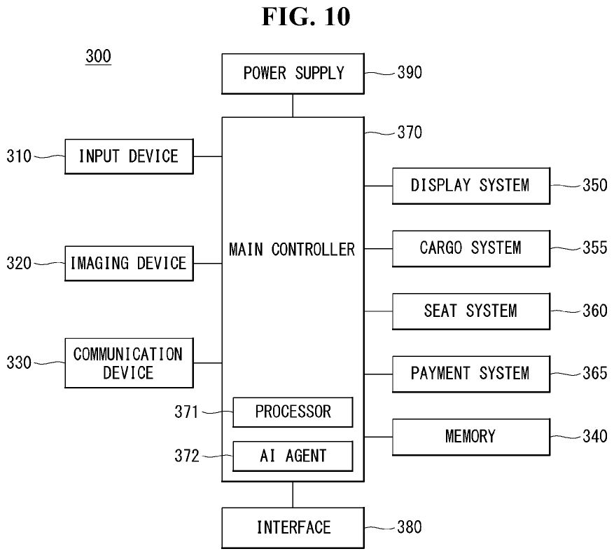

FIG. 10 illustrates V2X communication to which the present disclosure is applicable.

V2X communication includes communication between vehicle and all the entities, such as a vehicle-to-vehicle (V2V) designating communication between vehicles, a vehicle-to-infrastructure (V2I) designating communication between a vehicle and an eNB or an RSU (road side unit), vehicle-to-pedestrian (V2P) designating communication between UEs of a vehicle and an individual (pedestrians, bicycle drivers, vehicle drivers, or passengers), a vehicle-to-network (V2N), and the like.

A V2X communication may have the same meaning as a V2X sidelink or NR V2X or a wider meaning including a V2X sidelink or NR V2X.

The V2X communication may be applied to various services such as a forward collision warning, an automatic parking system, a cooperative adaptive cruise control (CACC), a control loss warning, a traffic queue warning, a traffic vulnerable people safety warning, emergency vehicle alarm, speed warning when traveling on winding road, traffic flow control, and the like.

V2X communication may be provided through a PC5 interface and/or the Uu interface. In this case, in a wireless communication system supporting V2X communication, there may exist certain network entities for supporting communication between the vehicle and all the entities. For example, the network entity may be an eNB, a roadside unit (RSU), a UE, or an application server (e.g., a traffic safety server).

In addition, the UE performing V2X communication may refer to a vehicle UE (V-UE), pedestrian UE, BS type (eNB type) RSU, a UE type RSU, a robot having a transceiver (or communication module), and the like, as well as a general handheld UE.

V2X communication may be performed directly between UEs or through the network entity(s). The V2X operation mode may be classified according to a method of performing V2X communication.

V2X communication is required to support pseudonymity and privacy of the UE when using a V2X application so that an operator or a third party may not track a UE identifier in V2X-supported region.

Terms frequently used in V2X communication are defined as follows.
RSU (road side unit): The RSU is a V2X serviceable device capable of transmitting/receiving with a moving vehicle using a V2I service. In addition, the RSU is a fixed infrastructure entity that supports a V2X application and may exchange messages with other entities that support the V2X application. RSU is a frequently used term in the existing ITS specification, and the reason for introducing this term in the 3GPP specification is to make it easier to read documents in the ITS industry. The RSU is a logical entity that combines the V2X application logic with functionality of a BS (referred to as a BS-type RSU) or a UE (referred to as a UE-type RSU).
V2I service: A type of V2X service, and an entity in which one side is a vehicle and the other side belongs to an infrastructure.
V2P service: A type of V2X service, one side thereof is a vehicle and the other side is a device carried by an individual (e.g., a portable UE carried by pedestrians, cyclists, drivers or passengers).
V2X service: A type of 3GPP communication service involving a transmission or reception device in a vehicle.
V2X enabled UE: UE supporting V2X service.
V2V service: A type of V2X service, both of which are vehicles.
V2V communication coverage: direct coverage between two vehicles participating in a V2V service.

The V2X application, called V2X (vehicle-to-everything), may include four types including (1) vehicle-to-vehicle (V2V), (2) vehicle-to-infrastructure (V2I), (3) vehicle-to-network (V2N), and (4) vehicle-to-pedestrian (V2P).

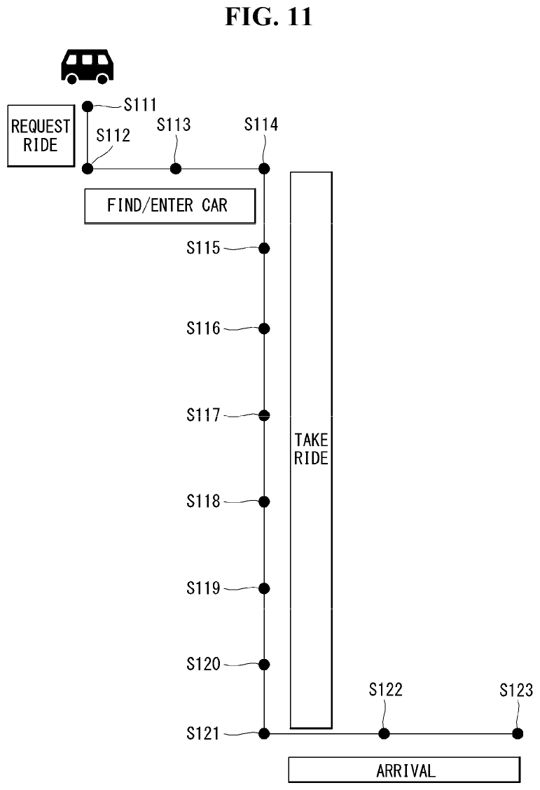

FIG. 11 illustrates a resource allocation method at a sidelink in which V2X is used.

In the sidelink, different physical sidelink control channels (PSCCHs) may be allocated to be spaced apart from each other in a frequency domain, and different physical sidelink shared channels (PSSCHs) may be allocated to be spaced apart from each other. Alternatively, the different PSCCHs may be continuously allocated in the frequency domain, and the PSSCHs may be continuously allocated in the frequency domain.

NR V2X

To extend the 3GPP platform to the automotive industry during 3GPP releases 14 and 15, support for V2V and V2X services was introduced in LTE.

The requirements for supporting an enhanced V2X use case are largely grouped into four use case groups.

(1) Vehicle platooning allows a platoon in which vehicles move together to be dynamically formed. Every vehicle in the platoon acquires information from a leading vehicle to manage the platoon. This information allows the vehicles to run in a more coordinated manner than in the normal direction and to travel in the same direction and run together.

(2) Extended sensors allow raw or processed data collected from a vehicle, a road side unit, a pedestrian device, and a V2X application server through a local sensor or a live video image to be exchanged. The vehicle may raise awareness of an environment more than its sensor may detect, and may recognize an area situation more broadly and collectively. A high data transfer rate is one of the main features.

(3) Advanced driving enables semi-automatic or fully-automatic operation. Each vehicle and/or RSU may share its own recognition data acquired from the local sensor with a nearby vehicle, and allow the vehicle to synchronize and adjust trajectory or maneuver. Each vehicle shares a driving intention with a nearby driving vehicle.

(4) Remote driving allows a remote operator or V2X application to remotely drive a vehicle for passengers who cannot travel on their own or in a dangerous environment. Cloud computing-based operations may be used if fluctuation is limited and a path may be predicted like public transportation. High reliability and low latency are key requirements.

The above-describe 5G communication technology can be combined with methods proposed in the present disclosure which will be described later and applied or can complement the methods proposed in the present disclosure to make technical features of the present disclosure concrete and clear.

In the autonomous driving system, when a driving pattern in which the autonomous vehicle threatens another vehicle occurs, it is difficult to know whether threatening drive is the problem of a vehicle or the problem of a passenger. Even when a dangerously driving vehicle is a vehicle that has learned a wrong driving pattern, it is difficult to recognize whether there is a problem with its own driving because the vehicle cannot determine whether the learning is correct or not. Furthermore, a particular passenger may make the vehicle learn a driving pattern in which the vehicle is driven maliciously dangerously whenever the vehicle is used.

Therefore, embodiments of the present disclosure can provide a method and an apparatus for managing the vehicle in the autonomous driving system, which is capable of changing a vehicle allocation option or verifying the driving status of the vehicle by determining a dangerous driving status based on the monitoring information of another vehicle and analyzing the dangerous driving cause of another vehicle.

The method and apparatus for managing the vehicle in the autonomous driving system according to the embodiment of the present disclosure may monitor the driving pattern of another vehicle, determine a dangerous driving vehicle based on the collected data, transmit a driving confirmation request to the server in the case of the dangerous driving vehicle, verify the driving status (passenger/vehicle) of the dangerous driving vehicle, change the vehicle allocation option according to the driving verification result, guide the transfer of the vehicle according to the changed vehicle allocation option, and immediately control the driving in the case of a dangerous driver.

The above-described autonomous driving system according to the embodiment of the present disclosure may ensure driving stability by quickly repairing the vehicle when a problem is found in the vehicle, initially identify a passenger who makes the vehicle learn a malicious pattern to reduce unnecessary software verification resources, guarantee both the driving stability of another autonomous vehicle and satisfaction when getting on the vehicle, and prevent an accident from occurring in advance.

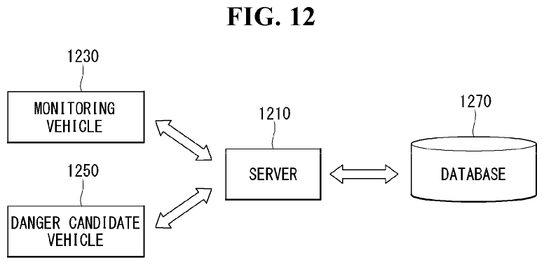

Hereinafter, the method and apparatus for managing the vehicle in the autonomous driving system according to the embodiment of the present disclosure will be described in detail with reference to FIGS. 12 to 28.

FIG. 12 shows an example of a block diagram of the autonomous driving system according to the embodiment of the present disclosure.

Referring to FIG. 12, the autonomous driving system includes a plurality of vehicles 1230 and 1250 that are driven along a predetermined path, a server 1210 that manages the driving of the plurality of vehicles 1230 and 1250, and a database that stores data on the plurality of vehicles, supplied from the server 1210. The plurality of vehicles 1230 and 1250 include a danger candidate vehicle 1250, and a monitoring vehicle 1230 that transmits data on the dangerous driving of the danger candidate vehicle 1250 to the server 1210.

The server 1210 is an apparatus for managing the driving of the vehicles 1230 and 1250 in the autonomous driving system. The server may receive data on the driving from the vehicles 1230 and 1250, process data required to drive the vehicles 1230 and 1250, and provide the processed data to the plurality of vehicles 1230 and 1250. Furthermore, the server 1210 may store the data received from the plurality of vehicles 1230 and 1250, the processed data, or relevant information in the database 1270.

Although FIG. 12 shows the monitoring vehicle 1230 and the danger candidate vehicle 1250 as the vehicle of the autonomous driving system, this is merely for the convenience of description and other vehicles may be included in the autonomous driving system. The monitoring vehicle 1230 and the danger candidate vehicle 1250 may be equal or similar to each other. Furthermore, the monitoring vehicle 1230 and the danger candidate vehicle 1250 may communicate with each other.

The basic configuration or operation of the monitoring vehicle 1230 and the danger candidate vehicle 1250 remains the same as the vehicle 10 of FIG. 5.

The database 1270 may store data on the driving of the vehicle provided from the server 1210, store data provided through another infrastructure, and provide the stored data to the server 1210. In an example of this specification, the database 1270 may be configured as an apparatus separate from the server 1210, but the database 1270 may be configured as an apparatus incorporated in the server 1210.

The server 1210 and the vehicles 1230 and 1250 may be connected to each other via a wireless network, and the server 1210 and the database 1270 may be connected to each other via a wired/wireless network or a wired interface.

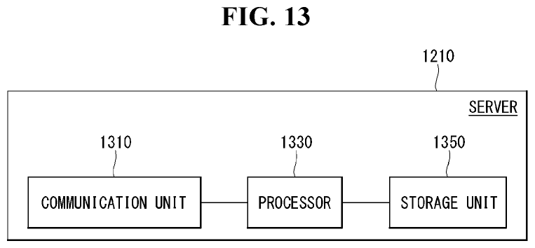

FIG. 13 shows an example of a block diagram of the server in the autonomous driving system according to an embodiment of the present disclosure. FIG. 13 shows an example of the server 1210 of FIG. 12.

The server 1210 of FIG. 13 includes a communication unit 1310 that is set to transmit or receive a signal to or from the plurality of vehicles 1230 and 1250, a processor 1330 that is functionally coupled with the communication unit 1310 and processes data on the plurality of vehicles 1230 and 1250, and a storage unit 1350 that is functionally coupled with the processor 1330 and stores data on the plurality of vehicles 1230 and 1250.

The communication unit 1310 may perform wired or wireless communication with another entity (e.g. the vehicle). The communication unit 1310 may include an antenna, an RF signal processing unit, and processing circuits for implementing wireless communication such as a baseband processing unit. The communication unit 1310 may also be referred to as a communication apparatus, a modem, a transceiver, a transmitter, or a receiver.

The processor 1330 may process data for performing the function of the server 1210, and control devices (e.g. the communication unit 1310, the storage unit 1350) included in the server 1210. The processor 1330 may be composed of one or more circuit modules for performing the calculation of the server 1210. The processor 1330 may also be referred to as a control unit, a controller, a processing circuitry, or a processing device.

The storage unit 1350 may store data required to operate the server 1210. The storage unit 1350 may also be referred to as a memory or a memory unit. Furthermore, the storage unit 1350 may include an interface to transmit data between the server 1310 and the database 1370.

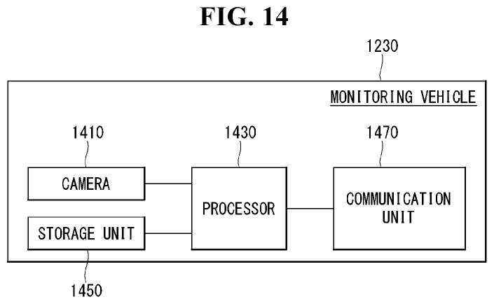

FIG. 14 shows an example of a block diagram of the monitoring vehicle in the autonomous driving system according to an embodiment of the present disclosure. FIG. 14 shows an example of the monitoring vehicle 1230 of FIG. 12.

In FIG. 14, the monitoring vehicle 1230 includes a camera 1410 that generates image data on the driving of another vehicle, a processor 1430 that is coupled with the camera 1410 and processes monitoring data on another vehicle, a storage unit 1450 that is coupled with the processor 1430 and stores monitoring data, and a communication unit 1470 that is coupled with the processor 1430 and transmits the monitoring data to the server 1210.

The camera 1410 may capture a surrounding image of the monitoring vehicle 1230 while the monitoring vehicle 1230 is driving, or may generate video data by combining the captured image. The camera 1410 may include a video lens and an image sensor for capturing an image.

The processor 1430 ma process data for performing the function of the monitoring vehicle 1230 or may control the operation of components included in the monitoring vehicle 1230. The storage unit 1450 may store data required to operate the monitoring vehicle 1230. The communication unit 1470 may perform the function of communicating with another entity. The processor 1430, the storage unit 1450, and the communication unit 1470 of the monitoring vehicle 1230 may be configured to perform functions that are substantially equal to the functions described in the autonomous driving apparatus 260 of FIG. 6.

FIG. 14 is only a simplified diagram to describe the embodiment of the present disclosure. In addition to components of FIG. 14, the monitoring vehicle 1230 may include components required to drive the vehicle, such as a driving unit or a frame.

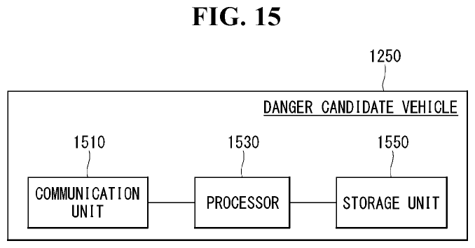

FIG. 15 shows an example of a block diagram of the danger candidate vehicle in the autonomous driving system according to an embodiment of the present disclosure. FIG. 15 shows an example of the danger candidate vehicle 1250 of FIG. 12.

In FIG. 15, the danger candidate vehicle 1250 includes a communication unit 1510 that transmits or receives data on the driving of the danger candidate vehicle 1250, a processor 1530 that is coupled with the communication unit 1510 and processes the data, and a storage unit 1550 that is coupled with the processor 1530 and stores the data.

The communication unit 1510, the processor 1530, and the storage unit 1550 included in FIG. 15 may perform substantially the same function as the communication unit 1470, the processor 1430, and the storage unit 1450 of FIG. 14.

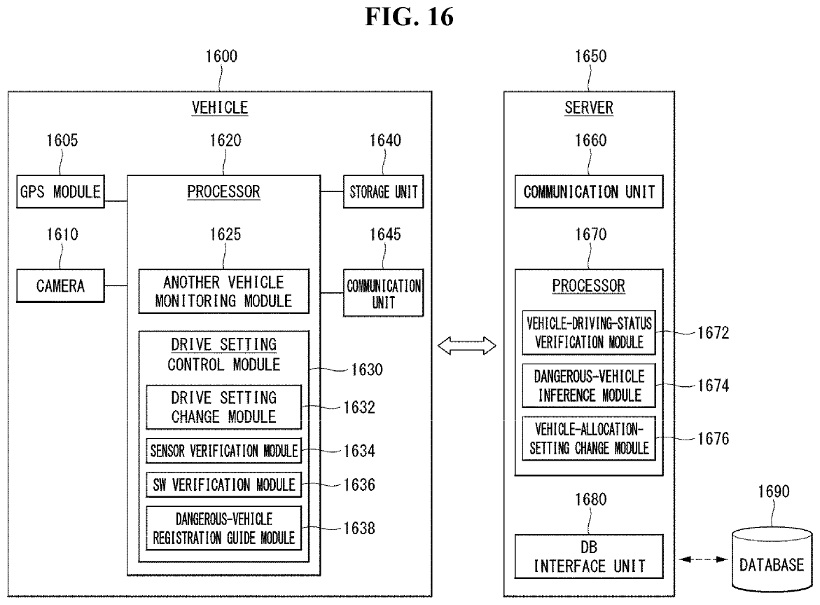

FIG. 16 shows another example of a block diagram of the autonomous driving system according to an embodiment of the present disclosure. FIG. 16 shows an example in which the autonomous driving system of FIG. 12 is differently expressed.

Referring to FIG. 16, the autonomous driving system includes a vehicle 1600 that is driven along a predetermined path, a server 1650 that manages the vehicle 1600, and a database that stores data provided from the server 1650 or provides the data to the server 1650.

The vehicle 1600 is a machine that is driven along a predetermined path, and corresponds to the vehicle 10 of FIG. 5. Furthermore, the vehicle 1600 of FIG. 16 may correspond to the monitoring vehicle 1230 or the danger candidate vehicle 1250 of FIG. 12.

Referring to FIG. 16, the vehicle 1600 includes a GPS module 1605 that provides information about a position of the vehicle 1600, a camera 1610 that generates image data on the driving of the vehicle 1600, a processor 1620 that controls the function of the vehicle 1600, a storage unit 1640 that stores data required for the processor 1620, and a communication unit 1645 that transmits or receives a signal to or from another entity.

The processor 1620 may include modules to perform various functions of the vehicle 1600. The processor 1620 may include another vehicle monitoring module 1625 for monitoring another vehicle, and a drive setting control module 1630 for controlling the drive setting of the vehicle 1600. Here, the drive setting control module 1630 may include a drive setting change module 1632 for changing the drive setting of the vehicle 1600, a sensor verification module 1634 for checking sensors of the vehicle 1600, a SW verification module 1636 for checking a software that controls the drive of the vehicle 1600, and a dangerous-vehicle registration guide module 1638 that informs a passenger of the registration of the dangerous vehicle when the vehicle 1600 is registered as the dangerous vehicle. The modules included in the processor 1620 may be configured as respective processing circuits or configured to be integrated into a processing circuit.

The server 1650 includes a communication unit 1660 that transmits or receives a signal to or from the vehicle 1600, a processor 1670 that controls the operation of the server 1650, and a DB interface unit 1680 that connects the server to the database 1690.

The processor 1670 may include a vehicle-driving-status verification module 1672 for checking the status of the vehicle 1600, a dangerous-vehicle inference module 1674 for determining whether the vehicle 1600 is the dangerous vehicle or not, and a vehicle-allocation-setting change module 1676 that is set to cause the passenger of the vehicle 1600 to get on another vehicle. Likewise, the modules included in the processor 1670 may be configured as respective processing circuits or configured to be integrated into a processing circuit.

The method and the apparatus for managing the vehicle in the autonomous driving system according to the embodiment of the present disclosure are as follows.

Driving Pattern Monitoring of Another Vehicle During Driving

The vehicles including the monitoring vehicle 1230 may collect the drive information of another vehicle. For example, the processor 1430 of the monitoring vehicle 1230 may store video data generated through the camera 1410 in the storage unit 1450, and may confirm the vehicle information and the drive information of another vehicle from image data. Here, the vehicle information may include a vehicle number, a vehicle model, or a vehicle color. Furthermore, the drive information may include the speed, position, and time of a vehicle, information about lane changes (the number of lane changes within a certain section), a distance between vehicles (a clearance when changing lanes), the number of abnormal overtaking, and the number of slamming on a brake.

When the dangerous drive is caused by a specific vehicle (the danger candidate vehicle 1250), the monitoring vehicle 1230 may transmit data on the dangerous drive by the danger candidate vehicle 1250 and a driving confirmation request message about the danger candidate vehicle 1250 to the server 1210. If a dangerous driving condition occurs from the drive information of another vehicle, the monitoring vehicle 1230 may store dangerous drive information about the dangerous driving condition as separate data. For example, the dangerous driving condition may include a case where the lane change occurs three or more times in one minute, a case where the clearance is less than 100 m when changing lanes, a case where the driving speed is equal to or more than a speed limit, a case where the number of abnormal overtaking (defending a vehicle from cutting in) are three or more times in a specific section, or a case where the number of slamming on the brake is three or more times in a specific section.

Method of Checking Dangerous Vehicle in Server

The server 1210 may receive the driving confirmation request message from several vehicles including the monitoring vehicle 1230 in the specific section and the data on the dangerous drive, and the vehicle information and the dangerous drive information of the danger candidate vehicle 1250 included in the data on the dangerous drive. For example, the dangerous drive information may include a dangerous drive kind, a monitoring position, and a monitoring time. Furthermore, the driving confirmation request message and the image data on the dangerous drive of the danger candidate vehicle 1250 may be attached.

The server 1210 receiving data on the dangerous drive from the monitoring vehicle 1230 determines whether the danger candidate vehicle 1250 is actually the dangerous vehicle or not. Specifically, the server 1210 may generate a danger candidate vehicle list from data on the dangerous drive received from several vehicles including the monitoring vehicle 1230 in a specific section.

Subsequently, a criterion (dangerous-vehicle classification criterion) for determining the continuity of the dangerous drive may be set depending on traffic on a current road (vehicle driving environment). Here, in the case where there is much traffic, the number at which the dangerous drive occurs in a specific section may be set as the dangerous-vehicle classification criterion. Meanwhile, in the case where there is little traffic, the number at which the dangerous drive occurs in a specific time may be set as the dangerous-vehicle classification criterion. The server 1210 may check the driving environment (traffic) around the danger candidate vehicle 1250 from the database 1270 or another server by referring to the position and the time of the dangerous drive caused by the danger candidate vehicle 1250.

Subsequently, the vehicle having the continuity of the dangerous drive may be determined as the dangerous vehicle. That is, when the dangerous drive information of the danger candidate vehicle 1250 satisfies the dangerous-vehicle classification criterion, the server 1210 may determine the danger candidate vehicle 1250 as the dangerous vehicle. If the danger candidate vehicle 1250 is determined as the dangerous vehicle, the server 1210 may store the vehicle information and the dangerous drive information of the danger candidate vehicle 1250 in the database 1270, and the server 1210 may check the drive (check a passenger or a vehicle drive) to analyze a dangerous drive factor. For example, data store in the database 1270 may include the vehicle information of the danger candidate vehicle 1250, the dangerous drive information, the passenger information, and the dangerous drive section. Here, the server 1210 may obtain the passenger information using the vehicle information of the danger candidate vehicle 1250 from the database 1270 or another server or database. The dangerous vehicle registration by the server 1210 may be updated for each section in space or time.

Method of Changing Next Vehicle Allocation Option Depending on Dangerous Driving Cause

The server 1210 verifies the passenger and the vehicle status of the danger candidate vehicle 1250 to analyze the dangerous driving cause of the danger candidate vehicle 1250. Both the verification for the passenger and the verification for the vehicle status may be performed, and only one of them may be performed. Furthermore, the verification for the passenger and the verification for the vehicle status may be performed simultaneously or sequentially.

First, the verification for the passenger and the method of changing the vehicle allocation option will be described. The verification for the passenger means the operation of checking whether the dangerous drive has occurred due to the malicious driving pattern of the passenger.

The server 1210 confirms the information about a passenger riding the danger candidate vehicle 1250. The passenger information of the danger candidate vehicle 1250 may be transmitted from the danger candidate vehicle 1250 to the server 1210 when the passenger gets on the danger candidate vehicle 1250, and the server 1210 may store information about the passenger in the database 1270 or the storage unit 1350. Furthermore, the server 1210 may receive the information about the passenger of the danger candidate vehicle 1250 from the danger candidate vehicle 1250 or another server. For example, the passenger information may include information whether a corresponding passenger is driving manually and information whether a previously boarded vehicle is registered as the dangerous vehicle.

Subsequently, the server 1210 may classify the danger level of a corresponding passenger based on the information about the identified passenger. Here, the server 1210 may designate the danger level of the passenger using some (e.g. recent 5 boarding records) of the records of vehicles on which the passenger of the danger candidate vehicle 1250 gets. For example, the danger level for the passenger may be divided into two levels, that is, a dangerous driving passenger and a driving-concerned passenger. Here, the dangerous driving passenger may correspond to a passenger when a case where a vehicle on which he or she gets is registered as the dangerous vehicle is 50% or more or a passenger who is driving manually. The driving-concerned passenger may correspond to a passenger when a case where a vehicle on which he or she gets is registered as the dangerous vehicle is less than 50% or a case where the vehicle is registered as the danger candidate vehicle is 30% or more. If the passenger of the danger candidate vehicle 1250 is neither the dangerous driving passenger nor the driving-concerned passenger, the server 1210 may determine that the danger candidate vehicle 1250 does not correspond to the dangerous vehicle, or may additionally verify the status of the danger candidate vehicle 1250.

Subsequently, the server 1210 may set the option for the vehicle allocation of the next vehicle depending on the danger level of the passenger. If a current passenger of the danger candidate vehicle 1250 corresponds to the dangerous driving passenger, the server 1210 may set to limit the manual driving of the current passenger for the danger candidate vehicle 1250 or the next vehicle on which the current passenger gets. Furthermore, if a current passenger of the danger candidate vehicle 1250 corresponds to the dangerous driving passenger or the driving-concerned passenger, the server 1210 may set a limit for a driving operation corresponding to the dangerous driving cause due to the danger candidate vehicle 1250 or the dangerous driving cause due to the vehicle on which the current passenger has previously gotten. Here, if the dangerous drive has occurred several times by the current passenger and the dangerous drive has various types, the server 1210 may set a limit (limit speed not to exceed regulation speed) on the driving operation corresponding to the type (e.g. speeding) of the danger drive that occurs most frequently

In addition to the verification for the passenger, the server 1210 may verify the status of the danger candidate vehicle 1250. Here, the vehicle status verification means the operation of verifying whether there is a problem with the sensor or software of the vehicle.

First, in order to verify the sensor of the danger candidate vehicle 1250, the server 1210 may transmit a sensor inspection request message for requesting the sensor verification to the danger candidate vehicle 1250. After checking the sensors installed in the danger candidate vehicle 1250, the danger candidate vehicle 1250 may transmit check data on the sensors to the server 1210.

Furthermore, in order to verify the software of the danger candidate vehicle 1250, the server 1210 may transmit a sample data set for checking the software as well as a software inspection request message for requesting the check of the software, to the danger candidate vehicle 1250. In response to the software inspection request message, the danger candidate vehicle 1250 may check the software using the received sample data set, and may transmit the software inspection result to the server 1210.

After checking the sensor and the software, the server 1210 may change the vehicle allocation setting depending on the sensor inspection result and the software inspection result of the danger candidate vehicle 1250. When it is determined that there is something wrong with the sensor or the software of the danger candidate vehicle 1250, the server 1210 may set the driving destination of the danger candidate vehicle 1250 as a garage or a repair shop. For example, when the defective sensor or the software verification error of the danger candidate vehicle 1250 is 30% of more, the server 1210 may set the driving destination of the danger candidate vehicle 1250 as the garage or the repair shop. Here, the defective sensor or the software verification error may be commonly referred to as a recognition error, and the allowable threshold value of the recognition error for changing the vehicle allocation option of the danger candidate vehicle 1250 may be set as a reference error. Furthermore, if the recognition error is less than 30%, the server 1210 may transmit additional learning data for additional learning of the danger candidate vehicle 1250. The danger candidate vehicle 1250 may download the additional learning data from the server 1210, and may increase a recognition rate for surrounding objects through the additional learning of the sensor and the software of the danger candidate vehicle 1250. After the danger candidate vehicle 1250 performs reinforcement learning for the sensor and the software with the additional learning data downloaded from the server 1210, the danger candidate vehicle may continue to drive.

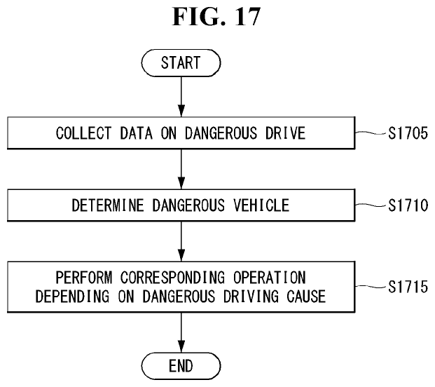

FIG. 17 shows an example of an operating method of a server in an autonomous driving system according to an embodiment of the present disclosure. FIG. 17 illustrates an example of a flowchart showing the operation of the server 1210 of FIG. 12.

The operating method of the server 1210 in the autonomous driving system according to the embodiment of the present disclosure includes a step S1705 of collecting data on the dangerous drive, a step S1710 of determining a dangerous vehicle based on the data on the dangerous drive, and a step S1715 of performing a corresponding operation depending on the dangerous driving cause of the dangerous vehicle.

At step S1705, the processor 1330 (dangerous-vehicle inference module 1674) of the server 1210 may collect the data on the dangerous drive, from a plurality of vehicles including the monitoring vehicle 1730. Here, the data on the dangerous drive may include the vehicle information of the danger candidate vehicle 1250 and the dangerous drive information of the danger candidate vehicle 1250. The vehicle information and the drive information of the danger candidate vehicle 1250 may be included in the driving confirmation request message, and the driving confirmation request message may attach the image data on the dangerous drive of the danger candidate vehicle 1250.

For example, the driving confirmation request message transmitted from the monitoring vehicle 1730 to the server 1210 may be the types of vehicle information/vehicle image/dangerous drive kind/monitoring position/monitoring time as follows.
Index 1: A vehicle/xxx/less than lane change clearance/in front of science park W5/10:00
Index 2: A vehicle/xxx/driving speed is speed limit or more (10 km/hour or more)/in front of science park W1/10:05
Index 3: A vehicle/xxx/sudden brake/in front of science park slc/10:07

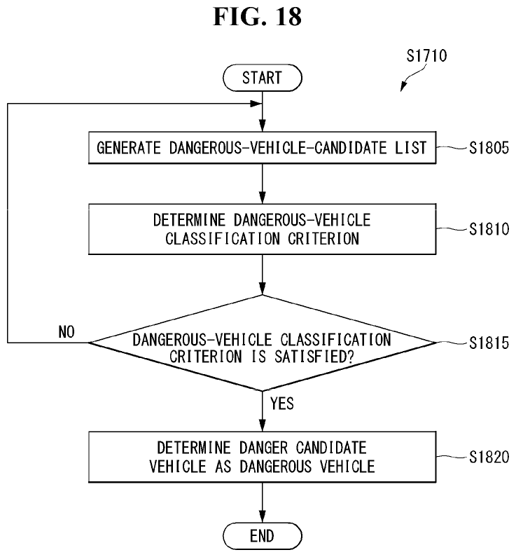

At step S1710, the processor 1330 (the vehicle-driving-status verification module 1672) of the server 1210 may confirm whether the danger candidate vehicle 1650 corresponds to the dangerous vehicle based on the data on the dangerous drive received from the monitoring vehicle 1230, and then may determine the danger candidate vehicle 1650 as the dangerous vehicle in the case of satisfying the condition. An operation of determining whether the danger candidate vehicle 1650 corresponds to the dangerous vehicle will be described later with reference to FIG. 18.

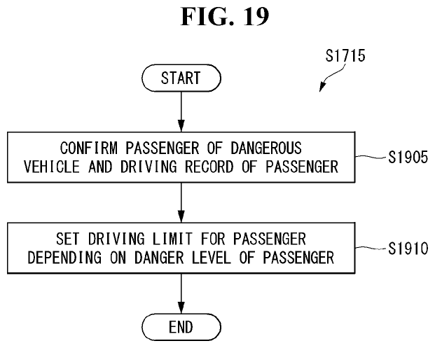

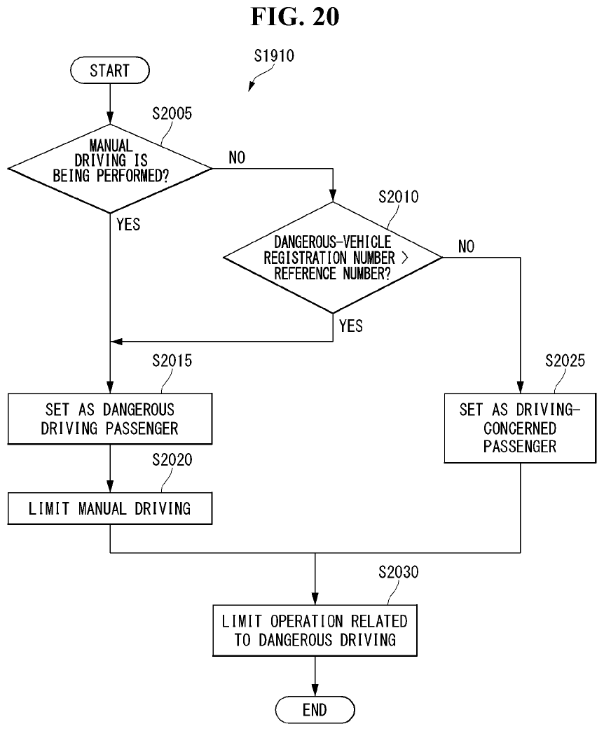

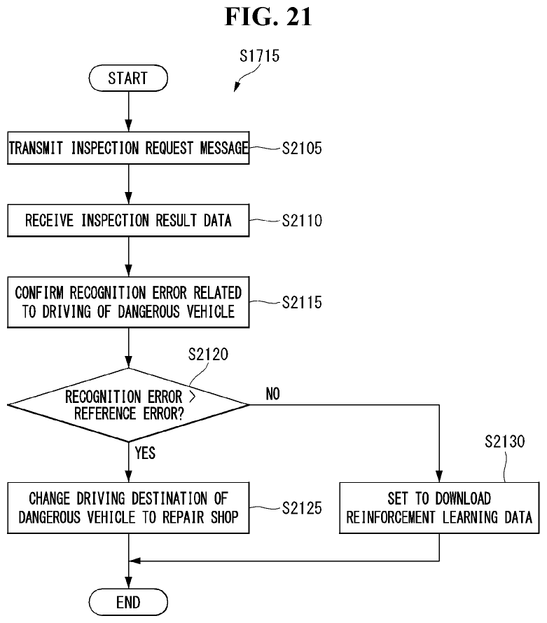

At step S1715, the processor 1330 (the vehicle-allocation-setting change module 1676) of the server 1210 may determine the dangerous driving cause of the danger candidate vehicle 1250 determined as the dangerous vehicle, and may perform a corresponding operation depending on the dangerous driving cause. Here, the dangerous driving cause may include a cause due to a passenger and a cause due to a vehicle status. The procedure of performing the corresponding operation depending on the cause due to the passenger will be described with reference to FIGS. 19 and 20, while the procedure of performing the corresponding operation depending on the cause due to the vehicle status will be described with reference to FIG. 21. Furthermore, the server 1210 may transmit a corresponding message depending on the dangerous drive to the danger candidate vehicle 1210 determined as the dangerous vehicle, and may store information (vehicle information, replacement vehicle information, dangerous driving cause) about the dangerous drive of the danger candidate vehicle 1210 in the database 1270.

FIG. 18 shows an example of the operating method of the server for determining the dangerous vehicle in the autonomous driving system according to the embodiment of the present disclosure. FIG. 18 shows an example of step S1710 of FIG. 17.

In the autonomous driving system according to the embodiment of the present disclosure, the step S1710 of determining the dangerous vehicle includes a step S1805 of generating a dangerous-vehicle-candidate list from the data on the dangerous drive, a step S1810 of determining a dangerous-vehicle classification criterion based on the driving environment information of the danger candidate vehicle included in the dangerous-vehicle-candidate list, a step S1815 of determining whether the dangerous drive information of the danger candidate vehicle satisfies the dangerous-vehicle classification criterion, and a step S1820 of determining the danger candidate vehicle as the dangerous vehicle by registering the vehicle information of the danger candidate vehicle in the dangerous vehicle database, if the dangerous drive information of the danger candidate vehicle satisfies the dangerous-vehicle classification criterion.

At step S1805, the processor 1330 (the dangerous-vehicle inference module 1674) of the server 1210 may generate the dangerous-vehicle-candidate list from the data on the dangerous drive of the danger candidate vehicle 1250 received from the monitoring vehicle 1230. Here, the data on the dangerous drive may include the vehicle information and the dangerous drive information. The dangerous drive information may include a dangerous drive type, a dangerous-drive generating position, and a dangerous-drive generating time.

The vehicle information and the drive information of the danger candidate vehicle 1250 may be included in the driving confirmation request message, and the driving confirmation request message may attach the image data on the dangerous drive of the danger candidate vehicle 1250.

For example, the driving confirmation request message transmitted from the monitoring vehicle 1730 to the server 1210 may be the types of vehicle information/vehicle image/dangerous drive kind/monitoring position/monitoring time as follows.
Index 1: A vehicle/xxx/less than lane change clearance/in front of science park W5/10:00
Index 2: A vehicle/xxx/driving speed is speed limit or more (10 km/hour or more)/in front of science park W1/10:05
Index 3: A vehicle/xxx/sudden brake/in front of science park slc/10:07

At step S1810, the processor 1330 (the dangerous-vehicle inference module 1674) of the server 1210 may determine the dangerous-vehicle classification criterion based on the data on the dangerous drive of the danger candidate vehicle 1250 included in the danger candidate vehicle candidate list. The dangerous-vehicle classification criterion may include a reference number where the dangerous drive occurs within a predetermined drive distance or a reference number where the dangerous drive occurs within a predetermined time range.

For example, in the case where there is much traffic, the general speed of the vehicle will be inevitably reduced (a moving distance is small even when time has passed), so that it is insignificant to know how far the vehicle moves within a predetermined time. Thus, it is important to know how often the dangerous drive occurs within a predetermined distance. In this case, the dangerous-vehicle classification criterion adopts the number where the dangerous drive occurs within a predetermined drive distance (e.g. 100 m).

On the other hand, in the case where there is little traffic, the general speed of the vehicle will be inevitably increased (a moving distance is large in a short period of time), so that it is insignificant to know how far the vehicle moves within a predetermined distance. Thus, it is important to know how often the dangerous drive occurs within a predetermined time range. In this case, the dangerous-vehicle classification criterion adopts the number where the dangerous drive occurs within a predetermined time. Here, the server 1210 may obtain information about traffic based on the time and position where the dangerous drive occurs due to the danger candidate vehicle 1250.

At step S1815, the processor 1330 (the dangerous-vehicle inference module 1674) of the server 1210 may determine whether the dangerous drive information caused by the danger candidate vehicle 1250 satisfies the dangerous-vehicle classification criterion.

For example, in the case where there is much traffic, the dangerous drive information of the danger candidate vehicle 1250 may be as follows.
A vehicle/xxx/less than lane change clearance/in front of science park W5/10:00
A vehicle/xxx/driving speed is speed limit or more (10 km/hour or more)/in front of science park W1/10:05
A vehicle/xxx/sudden brake/in front of science park slc/10:07

In this case, the dangerous-vehicle classification criterion is a case where the occurrence number of the dangerous drive is equal to or more than a reference number (3 times) within a reference section (100 m). If a distance from W5 to slc is 300 m, the dangerous drive occurs three times within the range of 300 m, so that the occurrence number of the dangerous drive becomes once within the range of 100 m. Therefore, since the occurrence number of the dangerous drive due to the danger candidate vehicle 1250 is smaller than the reference number (3 times) within the reference distance (100 m), it is determined at step S1820 that the danger candidate vehicle 1250 does not correspond to the dangerous vehicle.

In another example, in the case where there is little traffic, the dangerous drive information of the danger candidate vehicle 1250 may be as follows.
A vehicle/xxx/less than lane change clearance/in front of science park W5/10:00
A vehicle/xxx/driving speed is speed limit or more (10 km/hour or more)/in front of science park W1/10:02
A vehicle/xxx/sudden brake/in front of science park slc/10:03

In this case, the dangerous-vehicle classification criterion is a case where the occurrence number of the dangerous drive is the reference number (3 times) or more within a reference time (3 minutes). Here, since the number of the dangerous drive is equal to the reference number (3 times) within the reference time (3 minutes), it is determined at step S1820 that the danger candidate vehicle 1250 corresponds to the dangerous vehicle.

If it is determined at step S1820 that the danger candidate vehicle 1250 corresponds to the dangerous vehicle, the server 1210 may store the vehicle information and the dangerous drive information of the danger candidate vehicle 1250 in the database 1270 and may analyze the dangerous driving cause. Hereinafter, a case where the danger candidate vehicle 1250 is determined as the dangerous vehicle will be mainly described, and the danger candidate vehicle 1250 may be referred to as the dangerous vehicle.

FIG. 19 shows an example of an operating method of the server for performing a corresponding operation depending on the dangerous driving cause in the autonomous driving system according to the embodiment of the present disclosure. FIG. 19 shows an example of step S1715 of FIG. 17.

In the operating method of the server in the autonomous driving system according to the embodiment of the present disclosure, the step S1715 of performing the corresponding operation depending on the dangerous driving cause of the dangerous vehicle may include a step S1905 of confirming the passenger of the dangerous vehicle and the driving record of the passenger, and a step S1910 of setting the driving limit for the passenger depending on the danger level of the passenger determined based on the driving record of the passenger.

At step S1905, the processor 1330 (the vehicle-driving-status verification module 1672) of the server 1210 may confirm the information (passenger information) about the passenger of the danger candidate vehicle 1250 determined as the dangerous vehicle and the driving record of the passenger. Here, the driving record of the passenger may include the current driving type (manual driving) of the passenger and the driving record (dangerous driving record) of the vehicle on which the passenger got in the past.

At step S1910, the processor 1330 (vehicle-driving-status verification module 1672) of the server 1210 may determine the danger level of the passenger based on the driving record of the passenger of the danger candidate vehicle 1250, and may set the driving limit for the passenger based on the danger level of the passenger. The operation of setting the danger level of the passenger and the operation related to the driving limit setting will be described with reference to FIG. 20.

FIG. 20 shows an example of the operating method of the server for setting the driving limit for the passenger in the autonomous driving system according to the embodiment of the present disclosure. FIG. 20 shows an example of step S1910 of FIG. 19.

In the operating method of the server 1210 in the autonomous driving system according to the embodiment of the present disclosure, the step S1910 of setting the driving limit for the passenger may determine whether the passenger is driving manually at step S2005 and determine whether a dangerous-vehicle registration number of the passenger is more than a reference number at step S2010, and may include a step S2015 of setting the passenger as the dangerous driving passenger and a step S2020 of limiting the manual driving of the passenger, if the passenger is driving manually or the dangerous-vehicle registration number is larger than the reference number, a step S2025 of setting the passenger as the driving-concerned passenger, if the passenger is not driving manually or the dangerous-vehicle registration number is less than the reference number, and a step S2030 of limiting an operation related to the dangerous driving cause for the vehicle on which the passenger gets. The operating method of the server 1210 according to the embodiment shown in FIG. 20 will be described in detail.

At step S2005 and step S2010, the processor 1330 (vehicle-driving-status verification module 1672) of the server 1210 may obtain information about the passenger of the danger candidate vehicle 1250, and may confirm the driving record of the passenger of the danger candidate vehicle 1250. Here, the driving record of the passenger of the danger candidate vehicle 1250 may include the driving type (manual driving) of the passenger of the danger candidate vehicle 1250 and the dangerous-vehicle registration number of the vehicles on which the passenger got in the past. Based on the driving record of the passenger, the server 1210 may confirm whether the passenger of the danger candidate vehicle 1250 is currently driving manually and whether the dangerous-vehicle registration number of the previously boarding vehicles exceeds the reference number.

If the passenger of the danger candidate vehicle 1250 is driving manually or the dangerous-vehicle registration number is more than the reference number, at step S2015, the processor 1330 (vehicle-driving-status verification module 1672) of the server 1210 may set the passenger of the danger candidate vehicle 1250 as the dangerous driving passenger. In addition, at step S2020, the processor 1330 (vehicle-driving-status verification module 1672) of the server 1210 may limit the manual driving for the passenger of the danger candidate vehicle 1250.

If the passenger of the danger candidate vehicle 1250 is not driving manually and the dangerous-vehicle registration number is equal to or less than the reference number, at step S2025, the processor 1330 (vehicle-driving-status verification module 1672) of the server 1210 may set the passenger of the danger candidate vehicle 1250 as the driving-concerned passenger.

For example, if the passenger of the danger candidate vehicle 1250 is currently driving manually or a case where the vehicle on which the passenger gets is registered as the dangerous vehicle on the basis of recent 5 driving records is 50% or more (three or more times), the passenger of the danger candidate vehicle 1250 may be set as the dangerous driving passenger. Furthermore, if the passenger of the danger candidate vehicle 1250 is not driving manually or a case where the vehicle on which the passenger gets is registered as the dangerous vehicle on the basis of recent 5 driving records is less than 50% (three or more times), the passenger of the danger candidate vehicle 1250 may be set as the driving-concerned passenger. In addition, the server 1210 may consider the number at which the vehicle on which the passenger of the danger candidate vehicle 1250 got in the past is registered in the dangerous-vehicle-candidate list. For example, on the basis of recent 5 driving records, if the number at which the vehicle on which the passenger of the danger candidate vehicle 1250 got in the past is registered in the dangerous-vehicle-candidate list is 30% or more (two or more times), the server 1210 may set the passenger of the danger candidate vehicle 1250 as the driving-concerned passenger. Furthermore, on the basis of recent 5 driving records, if the number at which the vehicle on which the passenger of the danger candidate vehicle 1250 got in the past is registered in the dangerous-vehicle-candidate list is less than 30% (less than twice), the server 1210 may determine that the dangerous driving cause of the danger candidate vehicle 1250 is not the passenger, and may check the vehicle status of the danger candidate vehicle 1250.

In a further embodiment, the server 1210 may confirm recent 5 driving records of the passenger of the danger candidate vehicle 1250, may confirm monitoring data on dangerous driving in recent 20 sections, and may set the passenger of the danger candidate vehicle 1250 as the dangerous driving passenger in the case of being registered as the dangerous vehicle in 10 sections. Furthermore, the server 1210 may confirm recent 5 driving records of the passenger of the danger candidate vehicle 1250, may confirm monitoring data on dangerous driving in recent 20 sections, and may set the passenger of the danger candidate vehicle 1250 as the driving-concerned passenger in the case of being registered as the dangerous vehicle in 5 sections.

At step S2030, the processor 1330 (vehicle-driving-status verification module 1672) of the server 1210 may set to limit the operation related to the dangerous drive for the passenger of the danger candidate vehicle 1250. In other words, the server 1210 may set to prevent an operation related to the dangerous drive from occurring in a vehicle on which the passenger of the danger candidate vehicle 1250 or the danger candidate vehicle 1250 will subsequently get.

For example, if lane changes occur three or more times in one minute, the server 1210 may limit the lane changes that are not required for the driving path. Furthermore, if the clearance is less than 100 m when changing lanes, the server 1210 may permit the lane change only when a minimum clearance is 100 m. Furthermore, if the driving speed is equal to or more than the speed limit, the server 1210 may set the average driving speed of the vehicle as the speed limit for the corresponding road. Furthermore, if the number of abnormal overtaking (defending a vehicle from cutting in) is three or more times in a specific section, the server 1210 may limit the times of overtaking in the specific section within three times. Furthermore, if sudden brakes occur three or more times in the specific section, the server 1210 may be configured to keep a vehicle interval at least 30 m or more.

Furthermore, the server 1210 may transmit a corresponding message including corresponding information about the dangerous drive to the danger candidate vehicle 1250 determined as the dangerous vehicle due to the passenger. Here, the corresponding message may include a message (e.g. “A current vehicle is registered as the dangerous vehicle for 3 speeding violations.”) showing that the danger candidate vehicle 1250 is registered as the dangerous vehicle. Furthermore, the corresponding message may include a message (e.g. “Threatening drive due to speeding violation is found in four vehicles among five recently allocated vehicles.”) showing an existing dangerous drive history of the passenger. Furthermore, the corresponding message may include a guide message for restrictions on subsequent driving and a next vehicle allocation option (e.g. “Manual driving is limited and speed regulation is performed. The same option is applied to driving in the next vehicle allocation.”).

FIG. 21 shows another example of the operating method of the server for performing the corresponding operation depending on the dangerous driving cause in the autonomous driving system according to the embodiment of the present disclosure. FIG. 21 shows an example of step S1715 of FIG. 17.

In the operating method of the server 1210 in the autonomous driving system according to the embodiment of the present disclosure, the step of performing the corresponding operation depending on the dangerous driving cause of the dangerous vehicle may include a step S2105 of transmitting an inspection request message to the dangerous vehicle, a step S2110 of receiving inspection result data corresponding to the inspection request message from the dangerous vehicle, a step S2115 of confirming a recognition error related to the driving of the dangerous vehicle from the inspection result data, and a step of transmitting the corresponding message including the corresponding operation against the dangerous drive related to measures against the dangerous driving cause to the dangerous vehicle based on the recognition error. The step of transmitting the corresponding message may include a step S2125 of setting the dangerous-drive response operation of the corresponding message to change the driving destination to the repair shop of the dangerous vehicle if the recognition error is larger than the reference error, and a step S2130 of setting the dangerous-drive response operation of the corresponding message to download the reinforcement learning data for the additional learning of the dangerous vehicle if the recognition error is smaller than or equal to the reference error. Each of the operations shown in FIG. 17 may be performed by the processor 1330 (vehicle-allocation-setting change module 1676) of the server 1210.

Here, the inspection request message may include at least one of the inspection request for the sensor of the dangerous vehicle or the inspection request for the software related to the driving of the dangerous vehicle. The inspection result data may include the inspection result data on the sensor or sample data used for the software.

In FIG. 21, the recognition error represents the degree of the defective sensor or the software verification error of the danger candidate vehicle 1250, while the reference error represents the allowable threshold value of the recognition error for changing the vehicle allocation option of the danger candidate vehicle 1250.

For example, in the case of an object detecting function, the server 1210 may transmit the inspection request message including 10 photographs of a specific object as a sample, and may receive the recognition rate (accuracy) for the specific object from the danger candidate vehicle 1250. Furthermore, in the case of an interruption determining function, the server 1210 may receive information about the vehicle interval in an interruption simulation under a virtual driving condition.

Furthermore, the server 1210 may transmit a corresponding message including corresponding information about the dangerous drive to the danger candidate vehicle 1250 determined as the dangerous vehicle due to the vehicle status. Here, the corresponding message may include a message (e.g. “A current vehicle is registered as the dangerous vehicle for the failure of a right sensor” or “A current vehicle is registered as the dangerous vehicle for the failure of the SW.”) showing that the danger candidate vehicle 1250 is registered as the dangerous vehicle. Furthermore, the corresponding message may include a message (e.g. “The corresponding sensor needs to be returned to maintenance for the sake of safety” or “A current SW error rate is not large. Reinforcement learning is performed through data set learning. It will take about 20 seconds.”) showing a vehicle repairing method. Furthermore, the corresponding message may include a message (e.g. “A transfer vehicle is searched for the convenience of a passenger. The passenger is requested to transfer to 500 m A vehicle. The current vehicle is returned to maintenance.”) guiding the vehicle allocation for the repairing method.

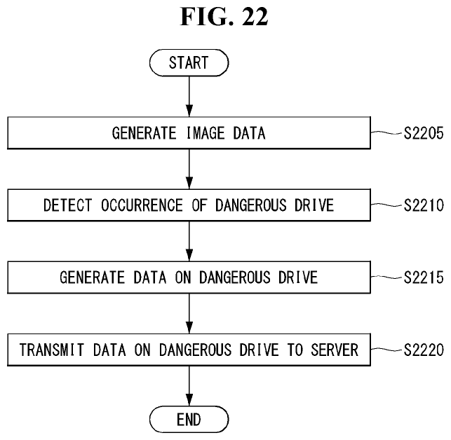

FIG. 22 shows an example of an operating method of a monitoring vehicle in the autonomous driving system according to the embodiment of the present disclosure. FIG. 22 shows an example of the operating method of the monitoring vehicle 1230 of FIG. 12.

The operating method of the monitoring vehicle 1230 in the autonomous driving system according to the embodiment of the present disclosure may include a step S2205 of generating image data on driving, a step S2210 of detecting the occurrence of the dangerous drive by the danger candidate vehicle from the image data, a step S2215 of generating data on the dangerous drive, and a step S2220 of transmitting data on the dangerous drive to the server.

Here, the data on the dangerous drive may include the vehicle information of the danger candidate vehicle and the dangerous drive information of the danger candidate vehicle. The dangerous drive information may include a dangerous drive type, a dangerous-drive generating position, and a dangerous-drive generating time.

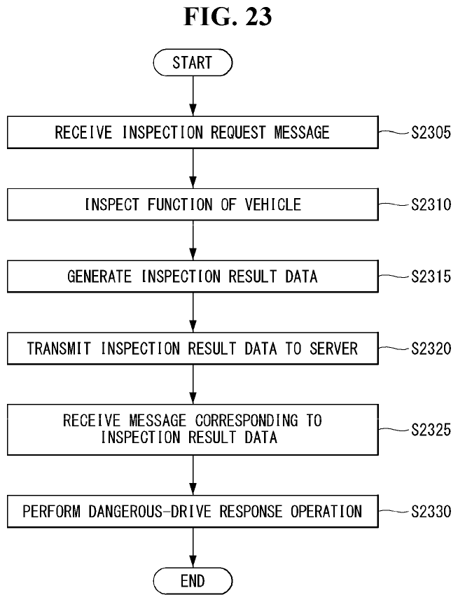

FIG. 23 shows an example of an operating method of a danger candidate vehicle in the autonomous driving system according to the embodiment of the present disclosure. FIG. 23 shows an example of a case where the danger candidate vehicle 1250 of FIG. 12 is determined as the dangerous vehicle.

The operating method of the danger candidate vehicle 1250 in the autonomous driving system according to the embodiment of the present disclosure may include a step S2305 of receiving an inspection request message from the server, a step S2310 of inspecting the function of the vehicle in response to the inspection request message, a step S2315 of generating inspection result data obtained by the inspection, a step S2320 of transmitting the inspection result data to the server, a step S2325 of receiving a message corresponding to the inspection result data from the server, and a step S2330 of performing a dangerous-drive response operation related to measures against the dangerous driving cause included in the corresponding message.

Here, the inspection request message may include at least one of the inspection request for the sensor of the vehicle or the inspection request for the software related to the driving of the vehicle, and the inspection result data may include the inspection result data on the sensor or the sample data used for the software.

Furthermore, the dangerous-drive response operation included in the corresponding message may include changing the vehicle's destination to the repair shop or downloading the reinforcement learning data for the additional learning of the vehicle.

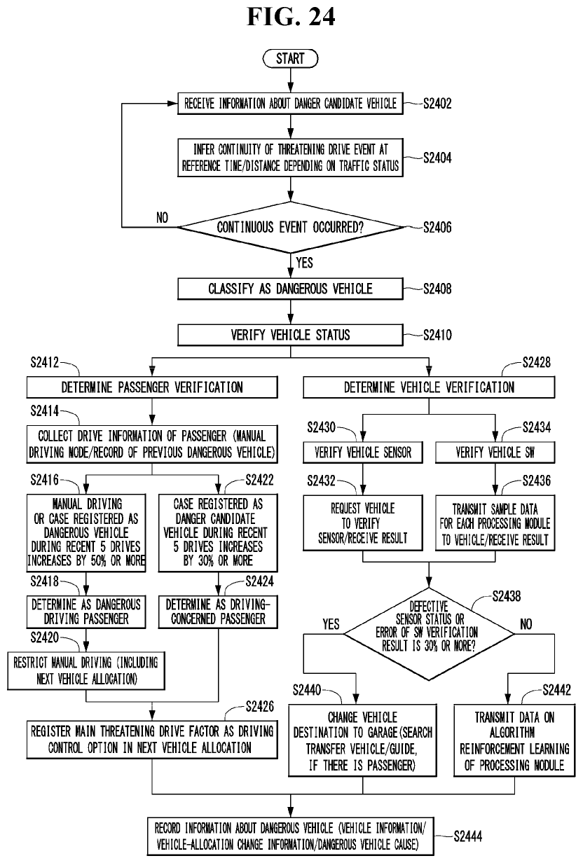

FIG. 24 shows another example of the operating method of the server in the autonomous driving system according to the embodiment of the present disclosure. The flowchart of FIG. 24 shows the entire operational flow of the server 1210 in the autonomous driving system according to the embodiment of the present disclosure.

At step S2402, the server 1210 may receive data on the dangerous drive by the danger candidate vehicle 1250 from a plurality of vehicles.

The server 1210 may set a reference time or distance depending on a traffic status (driving environment) of the danger candidate vehicle 1250 at step S2404, and may determine whether a dangerous drive event occurs continuously at the corresponding reference time or distance at step S2406.

If the dangerous drive event does not occur continuously by the danger candidate vehicle 1250, the server 1210 returns to step S2402 to continue to collect the dangerous drive data. Meanwhile, if it is determined that the dangerous drive event occurs continuously by the danger candidate vehicle 1250, the server 1210 may determine the danger candidate vehicle 1250 as the dangerous vehicle at step S2406, and then may determine to verify the danger candidate vehicle 1250.

The server 1210 may determine whether the dangerous drive of the danger candidate vehicle 1250 is caused by the passenger or the vehicle's status. In order to determine whether the dangerous drive of the danger candidate vehicle 1250 is caused by the passenger or not, the server 1210 may determine to verify the passenger at step S2412, and may collect the drive information of the passenger getting on the danger candidate vehicle 1250 at step S2414. Here, the drive information of the passenger may include information about whether the passenger is manually driving the danger candidate vehicle 1250 and a record of registering the vehicle on which the passenger got in the past as the dangerous vehicle. Based on the passenger drive information, the server 1210 may determine whether the passenger of the danger candidate vehicle 1250 is the dangerous driving passenger or the driving-concerned passenger.

If the server 1210 confirms at step S2416 that the passenger of the danger candidate vehicle 1250 is manually driving or a percentage registered as the dangerous vehicle during recent 5 drives is 50% or more, the corresponding passenger may be determined as the dangerous driving passenger at step S2418, and the manual driving of the corresponding passenger may be restricted at step S2420.

Furthermore, if the server 1210 confirms at step S2422 that a percentage registered in the danger candidate vehicle list during recent 5 drives performed by the passenger of the danger candidate vehicle 1250 is 30% or more, the corresponding passenger may be determined as the driving-concerned passenger at step S2424.

Subsequently, the server 1210 may register a driving control option so that a main dangerous driving item is not performed by the next vehicle of the corresponding passenger at step S2426.

Furthermore, the server 1210 may determine whether the dangerous drive of the danger candidate vehicle 1250 determined as the dangerous vehicle is caused by the status of the danger candidate vehicle 1250.

The server 1210 may determine to perform vehicle sensor verification for the danger candidate vehicle 1250 at step S2430, may request the danger candidate vehicle 1250 to verify the sensor at step S2432, and may receive the sensor verification result from the danger candidate vehicle 1250.

Furthermore, the server 1210 may determine to perform vehicle SW verification at step S2434, may transmit sample data for inspecting the software to the danger candidate vehicle 1250, and may receive the software inspection result from the danger candidate vehicle 1250.

Subsequently, the server 1210 determines whether the defective sensor status or the error of the software verification result of the danger candidate vehicle 1250 is 30% or more at step S2438. If the error is 30% or more, the server 1210 changes the destination of the danger candidate vehicle 1250 to the garage at step S2440, further searches the transfer vehicle and then transmits a guide message for the transfer vehicle to the passenger if there is the passenger. If the error is less than 30%, the server 1210 may transmit data of an algorithm for the reinforcement learning of the danger candidate vehicle 1250 to the danger candidate vehicle 1250 at step S2442.

Subsequently, the server 1210 may store the information of the danger candidate vehicle 1250 determined as the dangerous vehicle in the database 1270, and the information of the danger candidate vehicle 1250 may include vehicle information, vehicle-allocation change information, and information about the dangerous driving cause.

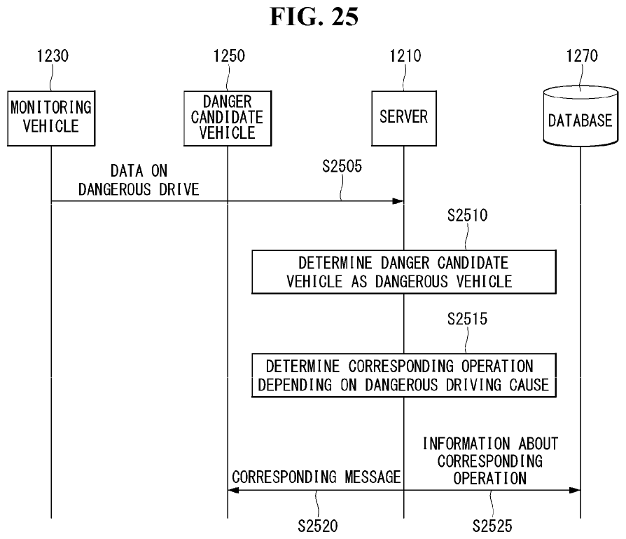

FIG. 25 shows an example of an operation flowchart for managing the vehicle in the autonomous driving system according to the embodiment of the present disclosure.

Referring to FIG. 25, the autonomous driving system may include a plurality of vehicles 1230 and 1250 that are driven along a predetermined path, a server 1210 that manages the driving of the plurality of vehicles 1230 and 1250, and a database 1270 that stores data on the plurality of vehicles 1230 and 1250, supplied from the server 1210. The plurality of vehicles 1230 and 1250 may include a danger candidate vehicle 1250, and a monitoring vehicle 1230 that transmits data on the dangerous driving of the danger candidate vehicle 1250 to the server 1210.

In an embodiment of the present disclosure, the server 1210 may collect data on the dangerous drive at step S2505, may determine the danger candidate vehicle as a dangerous vehicle based on the data on the dangerous drive at step S2510, may determine a corresponding operation depending on the dangerous driving cause of the danger candidate vehicle 1250 at step S2515, may transmit a corresponding message including the corresponding information about the corresponding operation to the danger candidate vehicle 1250 at step S2520, and may store the corresponding information in the database 1270 at step S2525.

Here, the data on the dangerous drive may include the vehicle information of the danger candidate vehicle 1250 and the dangerous drive information of the danger candidate vehicle 1250. Furthermore, the dangerous drive information may include at least one of a driving speed, the number of lane changes, a vehicle interval, and the number of braking operations.

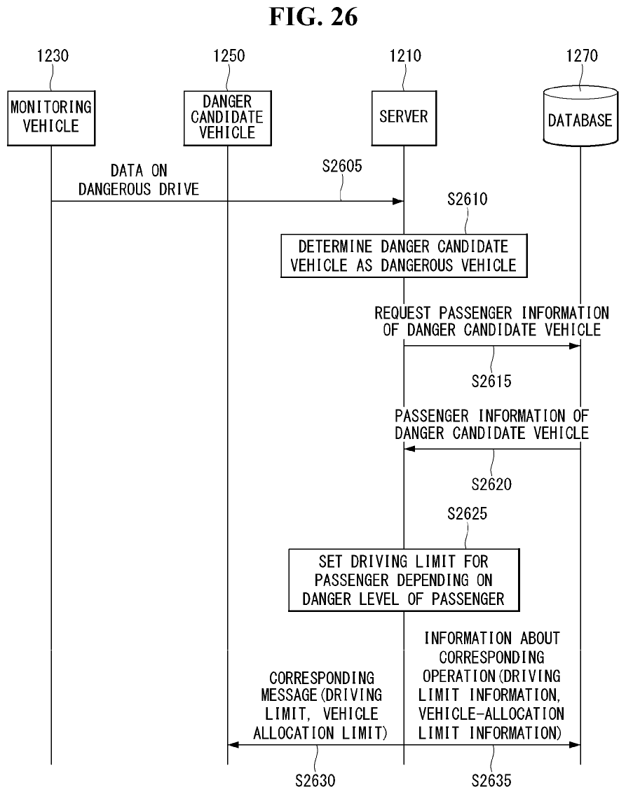

FIG. 26 shows another example of the operation flowchart for managing the vehicle in the autonomous driving system according to the embodiment of the present disclosure. Steps S2605, S2610, S2630 and S2635 of FIG. 26 are the same as steps S2505, S2510, S2520 and S2525 of FIG. 25, respectively.

Referring to FIG. 26, the server 1210 may transmit a message requesting the passenger information of the danger candidate vehicle 1250 to the database 1270 at step S2615, may confirm a passenger of the danger candidate vehicle 1250 received from the database 1270 and the driving record of the passenger at step S2620, and may set a driving limit for the passenger depending on the danger level of the passenger determined based on the driving record of the passenger at step S2625.

Here, the passenger's driving record may include a record about whether the passenger is manually driving and the number of registering vehicles on which the passenger got in the past as the dangerous vehicle.

Furthermore, if the passenger is driving manually or the dangerous-vehicle registration number is more than a reference number, the server 1210 may set the passenger as the dangerous driving passenger, and may limit the manual driving by the passenger. If the passenger is not driving manually and the dangerous-vehicle registration number is less than the reference number, the server may set the passenger as the driving-concerned passenger, and may set to limit operations related to the dangerous driving cause for the vehicle on which the passenger gets.

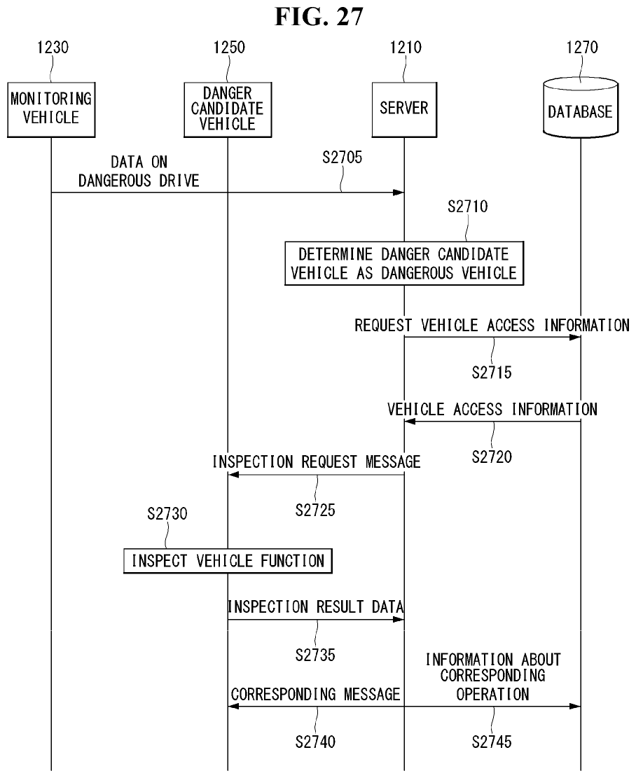

FIG. 27 shows a further example of the operation flowchart for managing the vehicle in the autonomous driving system according to the embodiment of the present disclosure. Steps S2705, S2710, S2740, and S2745 of FIG. 27 are the same as steps S2505, S2510, S2520 and S2525 of FIG. 25, respectively.

Referring to FIG. 27, the server 1210 may request vehicle access information for connecting the danger candidate vehicle to database 1270 at step S2715, may acquire the vehicle access information about the danger candidate vehicle from the database 1270 at step S2720, may transmit inspection request message to the danger candidate vehicle 1250 at step S2725, and may receive inspection result data corresponding to the inspection request message from the danger candidate vehicle 1250 at step S2735. Subsequently, the server 1210 may confirm a recognition error related to the driving of the danger candidate vehicle 1250 from the inspection result data, and may transmit the corresponding message including the corresponding operation against the dangerous drive related to measures against the dangerous driving cause to the danger candidate vehicle 1250 based on the recognition error. The dangerous-drive response operation included in the corresponding message may set to change the destination of the vehicle to the repair shop if the recognition error is larger than the reference error, and may set to download the reinforcement learning data for the additional learning of the vehicle if the recognition error is smaller than or equal to the reference error.

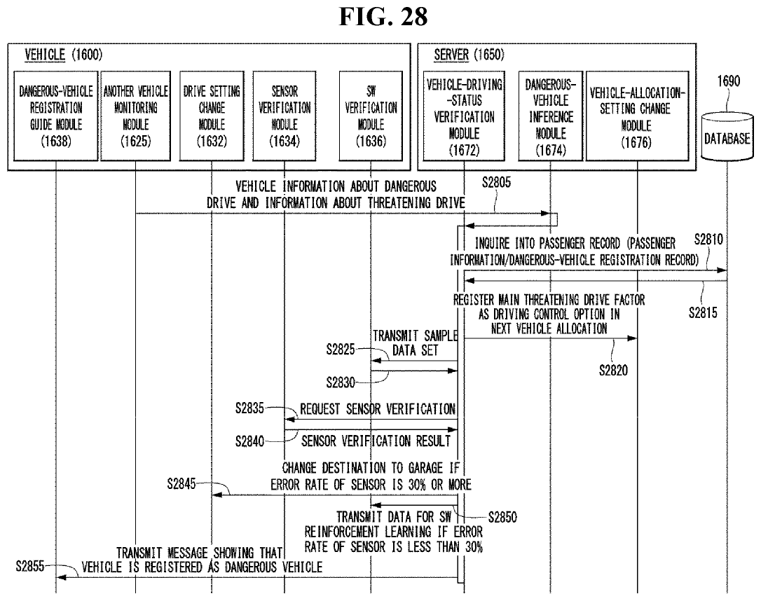

FIG. 28 shows yet another example of the operation flowchart for managing the vehicle in the autonomous driving system according to the embodiment of the present disclosure.

Referring to FIG. 28, another vehicle monitoring module 1625 of the vehicle 1600 corresponding to the monitoring vehicle 1230 transmits vehicle information and dangerous drive information of the danger candidate vehicle 1250 to the dangerous-vehicle inference module 1674 of the server 1650 at step S2805.

The dangerous-vehicle inference module 1674 of the server 1650 may determine the danger candidate vehicle 1250 as the dangerous vehicle on the basis of data on the dangerous drive including the vehicle information and the dangerous drive information of the danger candidate vehicle 1250.

The vehicle-driving-status verification module 1672 of the server 1650 may request the database 1690 to inquire into records (passenger information, dangerous-vehicle registration record) for the passenger of the danger candidate vehicle 1250 at step S2810, and may acquire the records (passenger information, dangerous-vehicle registration record) for the passenger of the danger candidate vehicle 1250 from the database 1690 at step S2815. Furthermore, if the danger candidate vehicle 1250 is determined as the dangerous vehicle by the vehicle-driving-status verification module 1650 of the server 1650, contents of the dangerous drive may be provided to the vehicle-allocation-setting change module 1676, and the vehicle-allocation-setting change module 1676 may set a driving limit option for the next vehicle of the corresponding passenger on the basis of the received dangerous-drive contents at step S2820.

Furthermore, the vehicle-driving-status verification module 1650 of the server 1650 may transmit a sample data set for inspecting the software to the SW verification module 1636 of the vehicle 1600 (danger candidate vehicle 1250) at step S2825, and may receive the software verification result from the SW verification module 1636 at step S2830.

Furthermore, the vehicle-driving-status verification module 1672 of the server 1650 may request the sensor verification module 1634 of the vehicle 1600 (danger candidate vehicle 1250) to inspect the sensor at step S2835, and may receive the sensor inspection result from the sensor verification module 1634 at step S2840.

Furthermore, if the error rate of the sensor or the software is 30% or more, the vehicle-driving-status verification module 1672 of the server 1650 may transmit a corresponding message to set the destination to the garage with the drive setting change module 1632 of the vehicle 1600 (danger candidate vehicle 1250) at step S2845. Meanwhile, if the error rate of the sensor or the software is less than 30%, the vehicle-driving-status verification module 1672 may transmit learning data for the software reinforcement learning to the SW verification module 1636 at step S2850.

Furthermore, the vehicle-driving-status verification module 1672 of the server 1650 may transmit a message showing that the vehicle is registered as the dangerous vehicle with the danger-vehicle registration guide module 1638 of the vehicle 1600 (danger candidate vehicle 1250) at step S2855.

The method and an apparatus for managing the drive of the vehicle in the autonomous driving system according to embodiments of the present disclosure are as follows:

### Embodiment 1

An operating method of a server for managing a drive of a vehicle in an autonomous driving system according to an embodiment of the disclosure includes collecting data on a dangerous drive of a danger candidate vehicle from a plurality of vehicles, determining whether the danger candidate vehicle is a dangerous vehicle or not on the basis of the data on the dangerous drive and information about a driving environment of the danger candidate vehicle, and performing an operation responding to a dangerous driving cause of the danger candidate vehicle if the danger candidate vehicle is the dangerous vehicle.

### Embodiment 2

The operating method of embodiment 1, wherein the collecting of the data on the dangerous drive may include receiving vehicle information of the danger candidate vehicle and dangerous drive information of the danger candidate vehicle from the plurality of vehicles.

### Embodiment 3

The operating method of embodiment 2, wherein the dangerous drive information may include a dangerous drive type, a dangerous-drive generating position, and a dangerous-drive generating time.

### Embodiment 4

The operating method of embodiment 3, wherein the determining whether the danger candidate vehicle is the dangerous vehicle may include generating a dangerous-vehicle-candidate list from the data on the dangerous drive, determining a dangerous-vehicle classification criterion on the basis of the information about the driving environment of the danger candidate vehicle included in the dangerous-vehicle-candidate list, determining whether the dangerous drive information of the danger candidate vehicle satisfies the dangerous-vehicle classification criterion, and determining the danger candidate vehicle as the dangerous vehicle by registering the vehicle information about the danger candidate vehicle in a dangerous vehicle database, if the dangerous drive information of the danger candidate vehicle satisfies the dangerous-vehicle classification criterion, wherein the dangerous-vehicle classification criterion may represent a criterion of an occurrence number of the dangerous drive within a predetermined drive distance or a predetermined time range.

### Embodiment 5

The operating method of embodiment 1, wherein the performing of the operation responding to the dangerous driving cause of the danger vehicle may include confirming a passenger of the dangerous vehicle and a driving record of the passenger, and setting a driving limit for the passenger depending on a danger level of the passenger determined on the basis of the driving record of the passenger.

### Embodiment 6

The operating method of embodiment 5, wherein the driving record of the passenger may include a record about which the passenger is manually driving and a dangerous-vehicle registration number of vehicles on which the passenger got in the past.

### Embodiment 7

The operating method of embodiment 6, wherein the setting of the driving limit for the passenger may include setting the passenger as a dangerous driving passenger and limiting the manual driving by the passenger if the passenger is manually driving or the dangerous-vehicle registration number is more than a reference number, setting the passenger as a driving-concerned passenger if the passenger is not manually driving or the dangerous-vehicle registration number is less than the reference number, and limiting an operation related to the dangerous driving cause for the vehicle on which the passenger gets.

### Embodiment 8

The operating method of embodiment 1, wherein the performing of the operation responding to the dangerous driving cause of the danger vehicle may include transmitting an inspection request message to the dangerous vehicle, receiving an inspection result data corresponding to the inspection request message from the dangerous vehicle, confirming a recognition error related to the drive of the dangerous vehicle from the inspection result data, and transmitting a corresponding message including a dangerous-drive response operation related to measures against the dangerous driving cause to the dangerous vehicle on the basis of the recognition error, the transmitting of the corresponding message may include setting the dangerous-drive response operation of the corresponding message to change a driving destination of the dangerous vehicle to a repair shop, if the recognition error is larger than a reference error, and setting the dangerous-drive response operation of the corresponding message to download reinforcement learning data for additional learning of the dangerous vehicle, if the recognition error is smaller than or equal to the reference error.

### Embodiment 9

The operating method of embodiment 8, wherein the inspection request message may include at least one of an inspection request for a sensor of the dangerous vehicle or an inspection request for a software related to a drive of the dangerous vehicle, and the inspection result data may include inspection result data on the sensor or sample data used for the software.

### Embodiment 10

The operating method of embodiment 8, wherein the performing of the operation responding to the dangerous driving cause of the danger vehicle may include storing vehicle information of the dangerous vehicle, replacement vehicle information of the dangerous vehicle, and the dangerous driving cause in the database.

### Embodiment 11

A server for managing a drive of a vehicle in an autonomous driving system includes a transceiver configured to transmit or receive a signal, a processor coupled to the transceiver, and a memory coupled to the processor, wherein the processor collects data on a dangerous drive of a danger candidate vehicle from a plurality of vehicles, determines whether the danger candidate vehicle is a dangerous vehicle or not on the basis of the data on the dangerous drive and information about a driving environment of the danger candidate vehicle, and performs an operation responding to a dangerous driving cause of the danger candidate vehicle if the danger candidate vehicle is the dangerous vehicle.

### Embodiment 12

The server of embodiment 11, wherein the processor may be configured to receive the vehicle information of the danger candidate vehicle and the dangerous drive information of the danger candidate vehicle from the plurality of vehicles through the transceiver.

### Embodiment 13

The server of embodiment 12, wherein the dangerous drive information may include a dangerous drive type, a dangerous-drive generating position, and a dangerous-drive generating time.

### Embodiment 14

The server of embodiment 13, wherein the processor generates a dangerous-vehicle-candidate list from the data on the dangerous drive, determines a dangerous-vehicle classification criterion on the basis of the information about the driving environment of the danger candidate vehicle included in the dangerous-vehicle-candidate list, determines whether the dangerous drive information of the danger candidate vehicle satisfies the dangerous-vehicle classification criterion, and determines the danger candidate vehicle as the dangerous vehicle by registering the vehicle information about the danger candidate vehicle in a dangerous vehicle database, if the dangerous drive information of the danger candidate vehicle satisfies the dangerous-vehicle classification criterion.

### Embodiment 15

The server of embodiment 11, wherein the processor confirms a passenger of the dangerous vehicle and a driving record of the passenger, and sets a driving limit for the passenger depending on a danger level of the passenger determined on the basis of the driving record of the passenger.

### Embodiment 16

The server of embodiment 15, wherein the driving record of the passenger may include a record about which the passenger is manually driving and a dangerous-vehicle registration number of vehicles on which the passenger got in the past.

### Embodiment 17

The server of embodiment 16, wherein the processor sets the passenger as a dangerous driving passenger and limits the manual driving by the passenger if the passenger is manually driving or the dangerous-vehicle registration number is more than a reference number, sets the passenger as a driving-concerned passenger if the passenger is not manually driving or the dangerous-vehicle registration number is less than the reference number, and limits an operation related to the dangerous driving cause for the vehicle on which the passenger gets.

### Embodiment 18

The server of embodiment 11, wherein the processor transmits an inspection request message to the dangerous vehicle through the transceiver, receives an inspection result data corresponding to the inspection request message from the dangerous vehicle through the transceiver, confirms a recognition error related to the drive of the dangerous vehicle from the inspection result data, and transmits through the transceiver a corresponding message including a dangerous-drive response operation related to measures against the dangerous driving cause to the dangerous vehicle on the basis of the recognition error, the dangerous-drive response operation included in the corresponding message is set as a destination changing operation of changing a destination of the vehicle to a repair shop, if the recognition error is larger than a reference error, and is set as an operation of downloading reinforcement learning data for additional learning of the dangerous vehicle, if the recognition error is smaller than or equal to the reference error.

### Embodiment 19

The server of embodiment 18, wherein the inspection request message may include at least one of an inspection request for a sensor of the dangerous vehicle or an inspection request for a software related to a drive of the dangerous vehicle, and the inspection result data may include inspection result data on the sensor or sample data used for the software.

### Embodiment 20

The server of embodiment 18, wherein the processor may be configured to store vehicle information of the dangerous vehicle, replacement vehicle information of the dangerous vehicle, and the dangerous driving cause in the database.

### Embodiment 21

An operating method of a vehicle monitoring another vehicle in an autonomous driving system includes generating image data on a drive, detecting a dangerous drive caused by a danger candidate vehicle from the image data, generating data on the dangerous drive, and transmitting the data on the dangerous drive to a server.

### Embodiment 22

The operating method of embodiment 21, wherein the data on the dangerous drive includes vehicle information of the danger candidate vehicle and dangerous drive information of the danger candidate vehicle, and the dangerous drive information may include a dangerous drive type, a dangerous-drive generating position, and a dangerous-drive generating time.

### Embodiment 23

A vehicle for monitoring another vehicle in an autonomous driving system includes a camera configured to generate image data on a drive of another vehicle, a processor coupled to the camera and configured to process monitoring data on another vehicle, a memory coupled to the processor and configured to store the monitoring data, and a transceiver coupled to the processor and configured to transmit the monitoring data to a server, wherein the processor may be configured to detect the dangerous drive caused by the danger candidate vehicle from the image data, to generate data on the dangerous drive, and to transmit the data on the dangerous drive to the server through the transceiver.

### Embodiment 24

The vehicle of embodiment 23, wherein the data on the dangerous drive includes vehicle information of the danger candidate vehicle and dangerous drive information of the danger candidate vehicle, and the dangerous drive information may include a dangerous drive type, a dangerous-drive generating position, and a dangerous-drive generating time.

### Embodiment 25

An operating method of a vehicle driven along a path in an autonomous driving system includes receiving an inspection request message from a server, inspecting a function of the vehicle in response to the inspection request message, generating inspection result data by the inspection, transmitting the inspection result data to the server, receiving a message corresponding to the inspection result data from the server, and performing a dangerous-drive response operation related to measures against a dangerous driving cause included in the corresponding message.

### Embodiment 26

The operating method of embodiment 25, wherein the inspection request message may include at least one of an inspection request for a sensor of the vehicle or an inspection request for a software related to a drive of the vehicle, and the inspection result data may include inspection result data on the sensor or sample data used for the software.

### Embodiment 27

The operating method of embodiment 25, wherein the dangerous-drive response operation included in the corresponding message may include a destination changing operation of changing a destination of the vehicle to a repair shop or an operation of downloading reinforcement learning data for additional learning of the vehicle.

### Embodiment 28

A vehicle driven along a path in an autonomous driving system includes a transceiver configured to transmit or receive data on a drive of the vehicle, a processor coupled to the transceiver and configured to process the data, a memory coupled to the processor and configured to store the data, wherein the processor receives the inspection request message from a server through the transceiver, inspects a function of the function of the vehicle in response to the inspection request message, generates inspection result data by the inspection, transmits the inspection result data to the server through the transceiver, receives a message corresponding to the inspection result data from the server through the transceiver, and performs a dangerous-drive response operation related to measures against a dangerous driving cause included in the corresponding message.

### Embodiment 29

The vehicle of embodiment 28, wherein the inspection request message may include at least one of an inspection request for a sensor of the vehicle or an inspection request for a software related to a drive of the vehicle, and the inspection result data may include inspection result data on the sensor or sample data used for the software.

### Embodiment 30

The vehicle of embodiment 28, wherein the dangerous-drive response operation included in the corresponding message may include a destination changing operation of changing a destination of the vehicle to a repair shop or an operation of downloading reinforcement learning data for additional learning of the vehicle.

### Embodiment 31

An autonomous driving system includes a plurality of vehicles driven along a predetermined path, a server managing a drive of the plurality of vehicles, and a database storing data on the plurality of vehicles, supplied from the server, wherein the plurality of vehicles include a danger candidate vehicle and a monitoring vehicle transmitting data on a dangerous drive of the danger candidate vehicle to the server, and the server collects the data on the dangerous drive, determines that the danger candidate vehicle is a dangerous vehicle on the basis of the data on the dangerous drive, determines an operation corresponding to the dangerous driving cause of the danger candidate vehicle, transmits a corresponding message including corresponding information about the corresponding operation to the danger candidate vehicle, and stores the corresponding information in a database.

### Embodiment 32

The autonomous driving system of embodiment 31, wherein the data on the dangerous drive includes vehicle information of the danger candidate vehicle and dangerous drive information of the danger candidate vehicle

### Embodiment 33

The autonomous driving system of embodiment 32, wherein the dangerous drive information may include at least one of a driving speed, the number of lane changes, a vehicle interval, and the number of braking operations.

### Embodiment 34

The autonomous driving system of embodiment 33, wherein the server generates a dangerous-vehicle-candidate list from the data on the dangerous drive, determines a dangerous-vehicle classification criterion on the basis of information about the driving environment of the danger candidate vehicle included in the dangerous-vehicle-candidate list, determines whether the dangerous drive information of the danger candidate vehicle satisfies the dangerous-vehicle classification criterion, and determines the danger candidate vehicle as the dangerous vehicle by registering the vehicle information about the danger candidate vehicle in a dangerous vehicle database, if the dangerous drive information of the danger candidate vehicle satisfies the dangerous-vehicle classification criterion.

### Embodiment 35

The autonomous driving system of embodiment 31, wherein the server may transmit a message requesting passenger information of the danger candidate vehicle to the database, may confirm the passenger of the danger candidate vehicle and the driving record of the passenger received from the database, and may set a driving limit for the passenger depending on a danger level of the passenger determined on the basis of the driving record of the passenger.

### Embodiment 36

The autonomous driving system of embodiment 35, wherein the driving record of the passenger includes a record about which the passenger is manually driving and a dangerous-vehicle registration number of vehicles on which the passenger got in the past.

### Embodiment 37

The autonomous driving system of embodiment 36, wherein the server may set the passenger as a dangerous driving passenger and limits the manual driving by the passenger if the passenger is manually driving or the dangerous-vehicle registration number is more than a reference number, may set the passenger as a driving-concerned passenger if the passenger is not manually driving or the dangerous-vehicle registration number is less than the reference number, and may limit an operation related to the dangerous driving cause for the vehicle on which the passenger gets

### Embodiment 38

The autonomous driving system of embodiment 31, wherein the server may request vehicle access information for connecting the danger candidate vehicle to the database, may acquire the vehicle access information about the danger candidate vehicle from the database, may transmit inspection request message to the danger candidate vehicle, may receive inspection result data corresponding to the inspection request message from the danger candidate vehicle, may confirm a recognition error related to the driving of the danger candidate vehicle from the inspection result data, and may transmit the corresponding message including the corresponding operation against the dangerous drive related to measures against the dangerous driving cause to the danger candidate vehicle on the basis of the recognition error. The dangerous-drive response operation included in the corresponding message may set to change the destination of the vehicle to the repair shop if the recognition error is larger than the reference error, and may set to download the reinforcement learning data for the additional learning of the vehicle if the recognition error is smaller than or equal to the reference error.

### Embodiment 39

The autonomous driving system of embodiment 38, wherein the inspection request message may include at least one of an inspection request for a sensor of the danger candidate vehicle or an inspection request for a software related to a drive of the danger candidate vehicle, and the inspection result data may include inspection result data on the sensor or sample data used for the software.

### Embodiment 40

The autonomous driving system of embodiment 38, wherein the server may include vehicle information of the danger candidate vehicle, replacement vehicle information of the danger candidate vehicle, and the dangerous driving cause in the database.

The present disclosure can be achieved by computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage, and may also be implemented in a carrier wave type (for example, transmission using the internet). Accordingly, the detailed description should not be construed as being limited in all respects and should be construed as an example. The scope of the present disclosure should be determined by reasonable analysis of the claims and all changes within an equivalent range of the present disclosure is included in the scope of the present disclosure.

Effects of a method and an apparatus for managing a vehicle in an autonomous driving system according to an embodiment of the present disclosure will be described as follows.

The present disclosure can realize a method and an apparatus for managing a vehicle capable of selecting a vehicle that causes a danger in an autonomous driving system by determining a dangerous vehicle, based on data about a dangerous drive, which is collected from vehicles.

The present disclosure can realize a method and an apparatus for managing a vehicle capable of removing a cause that induces a dangerous environment in an autonomous driving system by performing a corresponding operation depending on a dangerous driving cause of a dangerous vehicle.

The effects of the present disclosure are not limited to the effects described above and other effects can be clearly understood by those skilled in the art from the following description.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An operating method of a server for managing a drive of a vehicle in an autonomous driving system, comprising:
collecting data on a dangerous drive of a danger candidate vehicle from a plurality of vehicles;
determining whether the danger candidate vehicle is a dangerous vehicle or not on the basis of the data on the dangerous drive and information about a driving environment of the danger candidate vehicle; and
performing an operation responding to a dangerous driving cause of the danger candidate vehicle if the danger candidate vehicle is the dangerous vehicle.

2. The operating method of claim 1, wherein the collecting of the data on the dangerous drive comprises:
receiving vehicle information of the danger candidate vehicle and dangerous drive information of the danger candidate vehicle from the plurality of vehicles.

3. The operating method of claim 2, wherein the dangerous drive information comprises a dangerous drive type, a dangerous-drive generating position, and a dangerous-drive generating time.

4. The operating method of claim 3, wherein the determining whether the danger candidate vehicle is the dangerous vehicle comprises:
generating a dangerous-vehicle-candidate list from the data on the dangerous drive;
determining a dangerous-vehicle classification criterion on the basis of the information about the driving environment of the danger candidate vehicle included in the dangerous-vehicle-candidate list;
determining whether the dangerous drive information of the danger candidate vehicle satisfies the dangerous-vehicle classification criterion; and
determining the danger candidate vehicle as the dangerous vehicle by registering the vehicle information about the danger candidate vehicle in a dangerous vehicle database, if the dangerous drive information of the danger candidate vehicle satisfies the dangerous-vehicle classification criterion,
wherein the dangerous-vehicle classification criterion represents a criterion of an occurrence number of the dangerous drive within a predetermined drive distance or a predetermined time range.

5. The operating method of claim 1, wherein the performing of the operation responding to the dangerous driving cause of the danger vehicle comprises:
confirming a passenger of the dangerous vehicle and a driving record of the passenger; and
setting a driving limit for the passenger depending on a danger level of the passenger determined on the basis of the driving record of the passenger.

6. The operating method of claim 5, wherein the driving record of the passenger comprises a record about which the passenger is manually driving and a dangerous-vehicle registration number of vehicles on which the passenger got in the past.

7. The operating method of claim 6, wherein the setting of the driving limit for the passenger comprises:
setting the passenger as a dangerous driving passenger and limiting the manual driving by the passenger if the passenger is manually driving or the dangerous-vehicle registration number is more than a reference number;
setting the passenger as a driving-concerned passenger if the passenger is not manually driving or the dangerous-vehicle registration number is less than the reference number; and
limiting an operation related to the dangerous driving cause for the vehicle on which the passenger gets.

8. The operating method of claim 1, wherein the performing of the operation responding to the dangerous driving cause of the danger vehicle comprises:
transmitting an inspection request message to the dangerous vehicle;
receiving an inspection result data corresponding to the inspection request message from the dangerous vehicle;
confirming a recognition error related to the drive of the dangerous vehicle from the inspection result data; and
transmitting a corresponding message including a dangerous-drive response operation related to measures against the dangerous driving cause to the dangerous vehicle on the basis of the recognition error,
the transmitting of the corresponding message comprises:
setting the dangerous-drive response operation of the corresponding message to change a driving destination of the dangerous vehicle to a repair shop, if the recognition error is larger than a reference error; and
setting the dangerous-drive response operation of the corresponding message to download reinforcement learning data for additional learning of the dangerous vehicle, if the recognition error is smaller than or equal to the reference error.

9. The operating method of claim 8, wherein the inspection request message comprises at least one of an inspection request for a sensor of the dangerous vehicle or an inspection request for a software related to a drive of the dangerous vehicle, and
the inspection result data comprises inspection result data on the sensor or sample data used for the software.

10. The operating method of claim 8, wherein the performing of the operation responding to the dangerous driving cause of the danger vehicle comprises:
storing vehicle information of the dangerous vehicle, replacement vehicle information of the dangerous vehicle, and the dangerous driving cause in the database.

11. A server for managing a drive of a vehicle in an autonomous driving system, comprising:
a transceiver configured to transmit or receive a signal;
a processor coupled to the transceiver; and
a memory coupled to the processor,
wherein the processor collects data on a dangerous drive of a danger candidate vehicle from a plurality of vehicles, determines whether the danger candidate vehicle is a dangerous vehicle or not on the basis of the data on the dangerous drive and information about a driving environment of the danger candidate vehicle, and performs an operation responding to a dangerous driving cause of the danger candidate vehicle if the danger candidate vehicle is the dangerous vehicle.

12. The server of claim 11, wherein the processor is configured to receive the vehicle information of the danger candidate vehicle and the dangerous drive information of the danger candidate vehicle from the plurality of vehicles through the transceiver.

13. The server of claim 12, wherein the dangerous drive information comprises a dangerous drive type, a dangerous-drive generating position, and a dangerous-drive generating time.

14. The server of claim 13, wherein the processor generates a dangerous-vehicle-candidate list from the data on the dangerous drive, determines a dangerous-vehicle classification criterion on the basis of the information about the driving environment of the danger candidate vehicle included in the dangerous-vehicle-candidate list, determines whether the dangerous drive information of the danger candidate vehicle satisfies the dangerous-vehicle classification criterion, and determines the danger candidate vehicle as the dangerous vehicle by registering the vehicle information about the danger candidate vehicle in a dangerous vehicle database, if the dangerous drive information of the danger candidate vehicle satisfies the dangerous-vehicle classification criterion.

15. The server of claim 11, wherein the processor confirms a passenger of the dangerous vehicle and a driving record of the passenger, and sets a driving limit for the passenger depending on a danger level of the passenger determined on the basis of the driving record of the passenger.

16. The server of claim 15, wherein the driving record of the passenger comprises a record about which the passenger is manually driving and a dangerous-vehicle registration number of vehicles on which the passenger got in the past.

17. The server of claim 16, wherein the processor sets the passenger as a dangerous driving passenger and limits the manual driving by the passenger if the passenger is manually driving or the dangerous-vehicle registration number is more than a reference number, sets the passenger as a driving-concerned passenger if the passenger is not manually driving or the dangerous-vehicle registration number is less than the reference number, and limits an operation related to the dangerous driving cause for the vehicle on which the passenger gets.

18. The server of claim 11, wherein the processor transmits an inspection request message to the dangerous vehicle through the transceiver, receives an inspection result data corresponding to the inspection request message from the dangerous vehicle through the transceiver, confirms a recognition error related to the drive of the dangerous vehicle from the inspection result data, and transmits through the transceiver a corresponding message including a dangerous-drive response operation related to measures against the dangerous driving cause to the dangerous vehicle on the basis of the recognition error,
the dangerous-drive response operation included in the corresponding message is set as a destination changing operation of changing a destination of the vehicle to a repair shop, if the recognition error is larger than a reference error, and is set as an operation of downloading reinforcement learning data for additional learning of the dangerous vehicle, if the recognition error is smaller than or equal to the reference error.

19. The server of claim 18, wherein the inspection request message comprises at least one of an inspection request for a sensor of the dangerous vehicle or an inspection request for a software related to a drive of the dangerous vehicle, and the inspection result data comprises inspection result data on the sensor or sample data used for the software.

20. The server of claim 18, wherein the processor is configured to store vehicle information of the dangerous vehicle, replacement vehicle information of the dangerous vehicle, and the dangerous driving cause in the database.
